(19) United States
(12) Patent Application Publication
(10) Pub. No.: US 2005/0048252 A1
(43) Pub. Date: Mar. 3, 2005

(54) Substrate and storage media for data prepared therefrom

(76) Inventors: Irene Dris, Clifton Park, NY (US); Grant Hay, Evansville, IN (US); Eugene David Herrmann, Clifton Park, NY (US); Vijay R. Mhetar, Slingerlands, NY (US)

Correspondence Address: CANTOR COLBURN, LLP, 55 GRIFFIN ROAD SOUTH, BLOOMFIELD, CT, 06002, US

(21) Appl. No.: 10/648,609

(22) Filed: Aug. 26, 2003

(51) Int. Cl. G11B 7/24

(52) U.S. Cl. 428/65.1; 428/64.2; 369/275.4

(57) ABSTRACT

A disk substrate prepared from a blend of poly(arylene ether) resin and poly(alkenyl aromatic) resin is disclosed. The substrate can be used in data storage media having dimensional stability and good molded-in features.

### BACKGROUND OF INVENTION

This disclosure relates to a disk substrate and a data storage medium construction made from the substrate wherein the medium exhibits good dimensional stability upon exposure to varying environmental conditions.

Current high performance storage technologies, such as optical media, magnetic media, read-only media, write-once media, re-writable media, and magneto-optical (MO) media, provide various means of high storage capacity. Areal density, typically expressed as billions of bits per square inch of disk surface area (gigabits per square inch (Gbits/in²)), is equivalent to the linear density (bits of information per inch of track) multiplied by the track density in tracks per inch. Improved areal density has been one of the key factors in the price reduction per megabyte, and further increases in areal density of data storage media continue to be demanded by the industry.

The increase in data storage density is demanded to accommodate newer technologies, such as digital versatile disks (DVD) and higher density data disks for short and long-term data archives such as digital video recorders (DVR). The increase in areal density has resulted in increasingly stringent requirements of data storage media, including optical storage media. Optical data storage media with multiple layers (optical layer, data layer, and substrate layer in addition to optional layers), progressively shorter reading and writing wavelengths, and thinner optical layers moving toward “first surface” technologies have been the objects of intense efforts in the field of optical data storage devices. For such storage media, the optical quality of the optical layer is important. However, while the optical quality of the substrate is not relevant, the physical and mechanical properties of the substrate become increasingly important. For high areal density applications, including first surface applications, the surface quality of the storage media can affect the accuracy of the reading device, the ability to store data, and the replication qualities of the substrate. Furthermore, the physical characteristics of the storage media when in use can also affect the ability to store and retrieve data; i.e. the axial displacement of the media, if too great, can inhibit accurate retrieval of data and/or damage the read/write device.

Recent advances in high definition TV require a unique high density recording medium known in the industry as digital video recording (DVR) under the tradename BLU-RAY DISC. DVR disk assemblies generally comprise a data storage layer metallized onto a substrate and covered by an optical layer via a clear adhesive. The substrate is typically a polymeric material, which may or may not be the same material as the optical layer. This assembly must meet industry standard specifications for disk flatness, the deviation from which is known as radial tilt. A minimum change in radial tilt is required for the environments in which the assembly will be exposed during its use and throughout its lifetime.

Materials and methods for optimizing the physical and mechanical properties of data storage media are constantly being sought. Design requirements for the material used in optical data storage media include, for example, disk flatness (e.g., tilt), low water strain, low bireflingence, high transparency, heat resistance, ductility, high purity, and a minimum particulate impurity concentration in the substrate material. Low particulate concentration is desirable for an aesthetically pleasing product and to provide sufficient surface quality to maintain read accuracy, data storage, and replication. Currently employed materials are found to be lacking in one or more of the design requirements, and new materials are required in order to achieve higher data storage densities in optical data storage media. Consequently, a long felt yet unsatisfied need exists for data storage media that meets the design requirements, especially good dimensional stability and minimal tilt.

In addition to disk flatness, the disk assembly must also meet a minimum specification for feature replication. Typically a disk substrate is molded using a mold master containing a mold insert or “stamper” which comprises a pattern of features having particular dimensions in the micrometer or nanometer range. When molded, the disk substrate takes on the pattern of land and grooves as a “negative” of the stamper pattern. The replicated pattern must have features substantially identical in measurement to the pattern on the stamper. A 90 percent or greater replication of the stamper feature dimension is often required for storage media possessing high areal density capabilities.

It is difficult with currently available materials and methods to consistently and reliably meet the specifications required of data storage media having high areal density capabilities. Hence, there remains a need in the art for a data storage medium construction that maximizes the dimensional stability and groove dimension replication of the disk substrate.

### SUMMARY OF INVENTION

In one embodiment, a data storage medium, comprises a substrate layer comprising a blend of poly(arylene ether) resin and poly(alkenyl aromatic) resin; wherein the substrate layer comprises a surface comprising lands and grooves, wherein the lands and grooves comprise a pitch of about 0.05 to about 0.7 micrometer.

### BRIEF DESCRIPTION OF DRAWINGS

FIG. 1 is a depiction of the cross-section of a high areal optical data storage medium;

FIG. 2 is a graphical depiction of radial tilt as a function of time for a data disk assembly exposed to a humidity shock test, the assembly is made from a bisphenol-A polycarbonate substrate and a bisphenol-A polycarbonate optical layer;

FIG. 3 is a graphical depiction of radial tilt as a function of time for a data disk assembly exposed to a humidity shock test, the assembly is made from a poly(phenylene ether)/crystal polystyrene blend substrate and a 1,3-bis(4-hydroxyphenyl)menthane (BHPM) polycarbonate optical layer;

FIG. 4 is a graphical depiction of the radial tilt as a function of time for a data disk assembly exposed to a humidity shock test, the assembly is made from a poly(phenylene ether)/crystal polystyrene blend substrate and a bisphenol-A polycarbonate optical layer;

FIG. 5 is a graphical depiction of the change in radial tilt of data disk assemblies made from poly(phenylene ether)/crystal polystyrene blend substrates of varying molecular weight and constituent compositions and a BHPM polycarbonate optical layer; and

FIG. 6 is a graphical depiction of the percent shrinkage of a poly(phenylene ether)/crystal polystyrene blend substrate as a function of time when exposed to an 80° C. environment.

### DETAILED DESCRIPTION

The present disclosure describes asymmetrical data storage media assembly. In one embodiment, the data storage medium comprises a plurality of layers comprising a substrate layer comprising of a blend of poly(arylene ether) and poly(alkenyl aromatic) resins, a data layer disposed on the substrate layer, and an optical layer disposed on the data layer opposite to the substrate, wherein the optical layer comprises a polycarbonate. Optionally, the data storage medium for data further comprises a high modulus layer disposed over the optical layer opposite to the substrate.

The performance of data storage medium is affected by the degree of replication of the grooved pattern during the molding process of the substrate, as well as the storage medium flatness. For data storage media formats that are asymmetric (for example DVR or BLU-RAY DISC), the optical layer is often thinner than the supporting disk substrate and may be prepared from different materials. The asymmetric construction is particularly susceptible to disk tilt or curvature induced by changes in the surrounding environment, such as a change in temperature or humidity. The curvature induces spherical aberrations that lead to poor performance of the optical drive. Specific material compositions that provide improved dimensional stability of the total data disk assembly are disclosed herein. This technology minimizes curvature variation in the data disk medium assembly induced by environmental humidity and temperature changes.

Minimizing the change in data disk media tilt as the assembly is exposed to various environmental conditions is important for the retention of disk performance. Time, temperature, and humidity all play a role in affecting the tilt of an assembly comprising layers of material that exhibit differential rates of shrinkage or expansion when exposed to varying environmental conditions. Predictive tests for determining dimensional stability of a data disk assembly may be made by thermal aging the disk assembly at 80° C. for a predetermined time followed by measuring the radial tilt. Another predictive test includes exposing the data disk assembly to ambient temperature, but cycling the level of humidity while measuring the disk tilt during the cycling process.

It has been determined that the tendency for data disk assembly to tilt under a change in environmental conditions will depend on the composition of the optical layer and substrate layer as well as the processing conditions used to prepare the layers and the assembly. Herein we disclose specific compositions and processing conditions for minimizing radial tilt caused by heat and/or humidity while at the same time maximizing the degree of substrate replication.

As used herein, the term “tilt” refers to the number of radial degrees by which a data storage medium bends on a horizontal axis, and is typically measured as the vertical deviation at the outer radius of the storage medium. Typically, the maximum acceptable tilt range measured at a radius of 55 millimeters is about 0.50 degrees, and preferably, about 0.35 degrees. Typically the radial tilt is determined by measuring the deflection of a laser beam incident at some angle to the disk. From geometrical considerations the deflection of the laser beam is equal to two times the radial tilt angle. This is denoted as the radial deviation and is two times the tilt angle measured in degrees.

As mentioned, optical media format developers are currently moving towards re-recordable optical media formats having increased the areal density provided by adding extra information layers, decreasing laser wavelength, and/or increasing numerical aperture. To attain high areal densities in optical storage media the laser beam spot diameter (i.e., the diameter of the laser light beam that strikes the media) of the read/write device is preferably as small as possible. The laser beam spot diameter is roughly the wavelength of the laser light divided by the numerical aperture. The numerical aperture is the measure of the light-gathering capacity of the lens system. Current BLU-RAY DISC technology uses a blue laser, also known as a blue-violet laser, having a 405 nanometer wavelength; for comparison, the wavelength of the laser used to read CDs is 780 nanometers.

As the groove and land pattern of optical data storage disks are reduced in size to provide for increased areal density, the surface quality of the substrate comprising the pattern becomes increasingly important. Current optical data storage disks store data in a land and groove format with the data stored in the grooves or, alternatively, in both the grooves and the lands. The substrate of high areal disks is molded to comprise the land and groove pattern. For accurate data storage and retrieval, the land and groove pattern is desirably replicated on the disk substrate with a high degree of accuracy. As such, the material used to prepare the substrate should provide good replication as well as good surface smoothness. Particulate impurities such as gels and black specks at the surface of the molded substrate may interfere with the surface quality of the land and groove pattern. This is especially true as the land and groove patterns are reduced in size to smaller tracking pitches, groove depths, and widths to accommodate higher areal density. For example, current BLU-RAY DISC specifications have a pitch of about 320 nanometers with the corresponding groove depths and widths significantly smaller than the pitch.

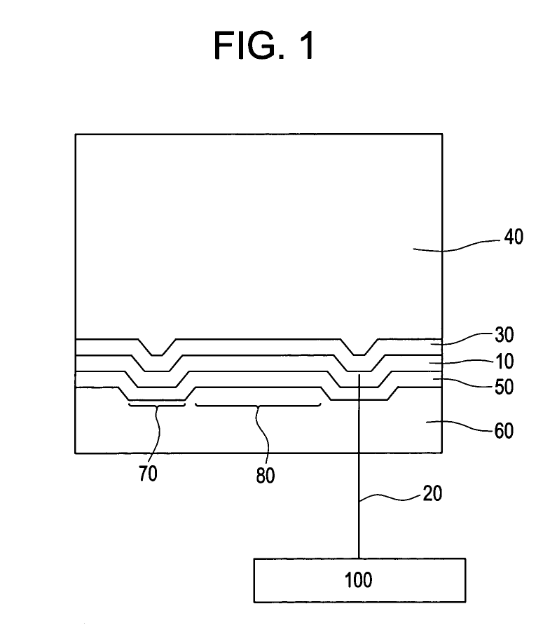

Referring to FIG. 1, for example, data retrieval comprises contacting the data storage layer 10 with a light beam 20 (white light, laser light, or other) incident on such layer. A reflective layer 30, disposed between the data storage layer 10 and substrate 40, reflects the light back through the data storage layer 10, adhesive layer 50, optical layer 60, and to the read/write device 100 where the data is retrieved. The groove 70 and land 80 format is shown in FIG. 1, which is not to scale.

In the context of the present disclosure, a typical data storage medium is composed of a plurality of polymeric and/or metallic components, which are generally combined in overlaying horizontal layers of various thicknesses, depending on the specific properties and requirements of the particular application of the data storage medium. A major component of a data storage medium is the substrate layer. The substrate layer is typically prepared from a polymeric material, preferably comprising a blend of poly(arylene ether) and poly(alkenyl aromatic) resins. The polymeric material should be capable of withstanding subsequent processing parameters (e.g., application of subsequent layers) such as sputtering temperatures of about room temperature (about 25° C.) up to about 150° C., and subsequent storage conditions (e.g., in a hot car having temperatures up to about 70° C.).

As used herein the term “thermoplastic polymer”, also referred to in the art as a thermoplastic resin, is defined as a material with a macromolecular structure that will repeatedly soften when heated and harden when cooled. Illustrative classes of thermoplastic polymers include, for example, styrene, acrylics, polyethylenes, vinyls, nylons, and fluorocarbons. As used herein the term “thermoset polymer”, also referred to in the art as a thermoset resin, is defined as a material which solidifies or cures when first heated, and which cannot be remelted or remolded without destroying its original characteristics. Illustrative classes of thermoset polymers include, for example, epoxides, melamines, phenolics, and ureas.

The substrate preferably comprises of a blend of poly(arylene ether) and poly(alkenyl aromatic) resins. The term poly(arylene ether) includes poly(phenylene ether) (PPE) and poly(arylene ether) copolymers; graft copolymers; poly(arylene ether) ether ionomers; and block copolymers of alkenyl aromatic compounds, vinyl aromatic compounds, and poly(arylene ether), and the like; and combinations comprising at least one of the foregoing; and the like. Poly(arylene ether)s per se, are known polymers comprising a plurality of structural units of the formula (I): 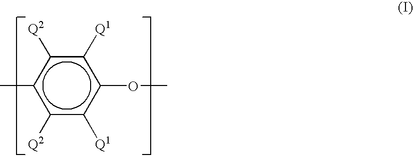
wherein for each structural unit, each Q¹ is independently halogen, primary or secondary lower alkyl (e.g., alkyl containing up to 7 carbon atoms), phenyl, haloalkyl, aminoalkyl, hydrocarbonoxy, or halohydrocarbonoxy wherein at least two carbon atoms separate the halogen and oxygen atoms, or the like; and each Q² is independently hydrogen, halogen, primary or secondary lower alkyl, phenyl, haloalkyl, hydrocarbonoxy, or halohydrocarbonoxy wherein at least two carbon atoms separate the halogen and oxygen atoms, or the like. It will be understood that the term “haloalkyl” includes alkyl groups substituted with one or more halogen atoms, including partially and fully halogenated alkyl groups. Preferably, each Q¹ is alkyl or phenyl, especially C₁-C₄ alkyl, and each Q² is hydrogen or C₁-C₄ alkyl.

Both homopolymer and copolymer poly(arylene ether)s are included. The preferred homopolymers are those containing 2,6-dimethylphenylene ether units. Suitable copolymers include random copolymers containing, for example, such units in combination with 2,3,6-trimethyl-1,4-phenylene ether units or copolymers derived from copolymerization of 2,6-dimethylphenol with 2,3,6-trimethylphenol. Also included are poly(arylene ether) containing moieties prepared by grafting vinyl monomers or polymers such as polystyrenes, as well as coupled poly(arylene ether) in which coupling agents such as low molecular weight polycarbonates, quinones, heterocycles, and formals undergo reaction in known manner with the hydroxy groups of two poly(arylene ether) chains to produce a higher molecular weight polymer. Poly(arylene ether)s further include combinations comprising at least one of the above. Preferred poly(arylene ether)s are poly(2,6-dimethylphenylene ether) and poly(2,6-dimethylphenylene ether-co-2,3,6-trimethylphenylene ether) such as those described in U.S. Pat. No. 6,407,200 to Singh et al. and U.S. Pat. No. 6,437,084 to Birsak et al.

The poly(arylene ether) generally has a number average molecular weight of about 3,000-40,000 atomic mass units (amu) and a weight average molecular weight of about 20,000-80,000 amu, as determined by gel permeation chromatography. The poly(arylene ether) may have an intrinsic viscosity (IV) in a range of about 0.10 deciliters per gram (dl/g) and about 0.60 dl/g, as measured in chloroform at 25° C. Within this range an IV of less than or equal to about 0.48 is preferred, and less than or equal to about 0.40 more preferred. Also preferred within this range is an IV of greater than or equal to about 0.29, with greater than or equal to about 0.33 dl/g more preferred. It is also possible to utilize a high intrinsic viscosity poly(arylene ether) and a low intrinsic viscosity poly(arylene ether) in combination. Determining an exact ratio, when two intrinsic viscosities are used, will depend somewhat on the exact intrinsic viscosities of the poly(arylene ether) used and the ultimate physical properties that are desired.

The poly(arylene ether)s are typically prepared by the oxidative coupling of at least one monohydroxyaromatic compound, for example 2,6-xylenol or 2,3,6-trimethylphenol. Catalyst systems generally employed for such coupling typically contain at least one heavy metal compound such as a copper, manganese, or cobalt compound, usually in combination with various other materials.

In one embodiment, the poly(arylene ether) comprises a capped poly(arylene ether). The capping may be used to prevent the oxidation of terminal hydroxy groups on the poly(arylene ether) chain. The terminal hydroxy groups may be inactivated by capping with an inactivating capping agent via an acylation reaction, for example. The capping agent chosen is desirably one that results in a less reactive poly(arylene ether) thereby reducing or preventing crosslinking of the polymer chains and the formation of gels or black specks during processing at elevated temperatures. Suitable capping agents include, for example, esters of salicylic acid, anthranilic acid, or a substituted derivative thereof, and the like; esters of salicylic acid, and especially salicylic carbonate and linear polysalicylates, are preferred. As used herein, the term “ester of salicylic acid” includes compounds in which the carboxy group, the hydroxy group, or both have been esterified. Suitable salicylates include, for example, aryl salicylates such as phenyl salicylate, acetylsalicylic acid, salicylic carbonate, and polysalicylates, including both linear polysalicylates and cyclic compounds such as disalicylide and trisalicylide. The preferred capping agents are salicylic carbonate and the polysalicylates, especially linear polysalicylates. When capped, the poly(arylene ether) may be capped to any desirable extent up to 80 percent, more preferably up to about 90 percent, and even more preferably up to 100 percent of the hydroxy groups are capped. The poly(arylene ether) may be capped in the reactor during the production of the polymer or the poly(arylene ether) may be capped by use of an extruder. Suitable capped poly(arylene ether) and their preparation are described in U.S. Pat. No. 4,760,118 to White et al. and U.S. Pat. No. 6,306,978 to Braat et al.

Capping poly(arylene ether) with polysalicylate is also believed to reduce the amount of aminoalkyl terminated groups present in the poly(arylene ether) chain. The aminoalkyl groups are the result of oxidative coupling reactions that employ amines in the process to produce the poly(arylene ether). The aminoalkyl group, ortho to the terminal hydroxy group of the poly(arylene ether), is susceptible to decomposition at high temperatures. The decomposition is believed to result in the regeneration of primary or secondary amine and the production of a quinone methide end group, which may in turn generate a 2,6-dialkyl-1-hydroxyphenyl end group. Capping of poly(arylene ether) containing aminoalkyl groups with polysalicylate is believed to remove such amino groups to result in a capped terminal hydroxy group of the polymer chain and the formation of 2-hydroxy-N,N-alkylbenzamine (salicylamide). The removal of the amino group and the capping provides a poly(arylene ether) that is more stable to high temperatures, thereby resulting in fewer degradative products, such as gels or black specks, during processing of the poly(arylene ether).

Based upon the foregoing, it will be apparent to those skilled in the art that the contemplated poly(arylene ether) resin may include many of those poly(arylene ether) resins presently known, irrespective of variations in structural units or ancillary chemical features.

The substrate may further comprise a poly(alkenyl aromatic) resin. The term “poly(alkenyl aromatic) resin” as used herein includes polymers prepared by methods known in the art including bulk, suspension, and emulsion polymerization, which contain at least 25 percent by weight of structural units derived from an alkenyl aromatic monomer of the formula (II): 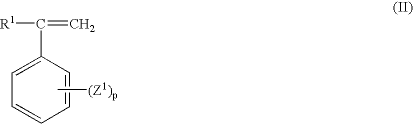
wherein R¹ is hydrogen, C₁-C₈ alkyl, or halogen; Z¹ is vinyl, halogen, or C₁-C₈ alkyl; and p is in a range between 0 and about 5. Preferred alkenyl aromatic monomers include styrene, chlorostyrene, and vinyltoluene. The poly(alkenyl aromatic) resins include homopolymers of an alkenyl aromatic monomer; random copolymers of an alkenyl aromatic monomer, such as styrene, with one or more different monomers such as acrylonitrile, butadiene, alpha-methylstyrene, ethylvinylbenzene, divinylbenzene and maleic anhydride; and rubber-modified poly(alkenyl aromatic) resins comprising blends and/or grafts of a rubber modifier and a homopolymer of an alkenyl aromatic monomer (as described above), wherein the rubber modifier may be a polymerization product of at least one C₄-C₁₀ non-aromatic diene monomer, such as butadiene or isoprene, and wherein the rubber-modified poly(alkenyl aromatic) resin comprises in a range of about 98 weight percent and about 70 weight percent of the homopolymer of an alkenyl aromatic monomer and in a range of about 2 weight percent and about 30 weight percent of the rubber modifier, preferably in a range of about 88 weight percent and about 94 weight percent of the homopolymer of an alkenyl aromatic monomer and in a range of about 6 weight percent and about 12 weight percent of the rubber modifier. These rubber-modified polystyrenes include high impact polystyrene commonly referred to as HIPS.

The poly(alkenyl aromatic) resins also include non-elastomeric block copolymers, for example diblock, triblock, and multiblock copolymers of styrene and a polyolefin. Non-elastomeric block copolymer compositions of styrene and butadiene can also be used that have linear block, radial block, or tapered block copolymer architectures wherein the butadiene component is present up to about 35 weight percent. Suitable non-elastomeric block copolymers are commercially available from such companies as Atofina as under the trademark FINACLEAR and Chevron Phillips Chemical Company under the trademark K-RESINS.

The poly(alkenyl aromatic) resins may also include block copolymers of styrene-polyolefin-methyl methacrylate. A preferred block copolymer of this type includes poly(styrene-b-1,4butadiene-b-methyl methacrylate) (SBM) available from Atofina comprising blocks of polystyrene, 1,4-polybutadiene, and syndiotactic polymethyl methacrylate. SBM block copolymers available from Atofina include AF-X223, AF-X333, AF-X012, AF-X342, AF-X004, and AF-X250.

The stereoregularity of the poly(alkenyl aromatic) resin may be atactic or syndiotactic. Highly preferred poly(alkenyl aromatic) resins include atactic and syndiotactic homopolystyrenes. Suitable atactic homopolystyrenes are commercially available as, for example, EB3300 from Chevron, and P1800 from BASF. Atactic homopolystyrenes are sometimes referred to herein as “crystal polystyrene” resins. Useful syndiotactic polystyrene resins (SPS) are available from The Dow Chemical Company under the QUESTRA trademark.

The poly(alkenyl aromatic) preferably has a number average molecular weight of about 20,000-100,000 amu and a weight average molecular weight of about 10,000-300,000 amu.

The substrate is preferably prepared from a blend of poly(arylene ether) resin and poly(alkenyl aromatic) resin. The blend may contain poly(arylene ether) in a range of about 1 weight percent and about 99 weight percent based on the total weight of poly(arylene ether) and poly(alkenyl aromatic) resins. Within this range, the ratio of poly(arylene ether) and poly(alkenyl aromatic) resins can be adjusted depending, among other things, on the physical properties desired, e.g., heat resistance. Typically the ratio of poly(arylene ether) and poly(alkenyl aromatic) resins is adjusted so as to result in a blended material having a glass transition temperature (Tg) of at least about 120° C. Two or more poly(arylene ether) resins and/or two or more poly(alkenyl aromatic) resins may also be used to achieve the desired physical properties. Generally, the amount of poly(arylene ether) used in the blend may be less than or equal to about 80 weight percent, with less than or equal to about 70 weight percent preferred, less than or equal to about 60 weight percent more preferred, and less than or equal to about 50 weight percent even more preferred based on the total weight of poly(arylene ether) and poly(alkenyl aromatic). Also preferred within this range is an amount of poly(arylene ether) of greater than or equal to about 20 weight percent, with greater than or equal to about 30 weight percent preferred, and greater than or equal to about 40 weight percent more preferred. The amount of poly(alkenyl aromatic) in the blend may be less than or equal to about 80 weight percent, with less than or equal to about 70 weight percent preferred, less than or equal to about 60 weight percent more preferred, and less than or equal to about 50 weight percent even more preferred based on the total weight of poly(arylene ether) and poly(alkenyl aromatic). Also preferred within this range is an amount of poly(alkenyl aromatic) of greater than or equal to about 20 weight percent, with greater than or equal to about 30 weight percent preferred, and greater than or equal to about 40 weight percent more preferred.

The blend of poly(arylene ether) and poly(alkenyl aromatic) preferably has a Tg greater than or equal to about 120° C., preferably greater than or equal to about 130° C., more preferably greater than or equal to about 140° C., and even more preferably greater than or equal to about 150° C.

In one embodiment, the substrate comprises a blend of poly(arylene ether) and poly(alkenyl aromatic) substantially free of particulate impurities. Due to the surface quality requirements of high areal density storage media, it is desirable that current data storage media are prepared from materials containing limited quantities of particulate impurities, whether inorganic or organic. Visible particulate impurities, such as gels and carbonized polymeric material (black specks), are undesirable as an aesthetic defect resulting in a consumer's perception of an inferior quality product. Particles having sizes larger than about 50 micrometers may act as stress concentrators in molded articles, thereby reducing the impact strength of these articles. Particulate impurities about 1 micrometer in size may contribute to an increase in haze which can affect the transmittance of light through or transparency of articles molded from material containing such impurities. Most importantly, particulate impurities may affect surface quality of storage media thereby affecting read accuracy, data storage, and replication.

Preferred methods to prepare the poly(arylene ether)/poly(alkenyl aromatic) blends having reduce quantities of particulate impurities are disclosed in application Ser. No. ______, attorney docket no. 135946-1 entitled “Methods of Preparing a Polymeric Material Composite”; application Ser. No. ______, attorney docket no. 131982-1 entitled “Methods of Preparing a Polymeric Material”; and application Ser. No. ______, attorney docket no. 126750-1 entitled “Methods of Purifying Polymeric Material” all filed on ______, commonly owned and co-pending with the present application. The methods described in the co-pending applications provide a blend comprising poly(arylene ether) and poly(alkenyl aromatic) that is substantially free of particulate impurities. The methods described include melt filtering melts comprising poly(arylene ether) and poly(alkenyl aromatic), filtering solutions comprising poly(arylene ether), poly(alkenyl aromatic), or a combination thereof; or combinations of melt filtration and solution filtration to result in a blend of poly(arylene ether) and poly(alkenyl aromatic) substantially free of particulate impurities.

As used herein, the term “substantially free of visible particulate impurities” means that a ten gram sample of a polymeric material dissolved in fifty milliliters of chloroform (CHCl₃) exhibits fewer than 5 visible specks when viewed with the aid of a light box. Particles visible to the naked eye are typically those greater than 40 micrometers in diameter.

As used herein, the term “substantially free of particulate impurities greater than about 15 micrometers” means that of a forty gram sample of polymeric material dissolved in 400 milliliters of CHCl₃, the number of particulates per gram having a size of about 15 micrometers is less than 50, as measured by a laser light scattering technique based on the average of five samples of twenty milliliter quantities of the dissolved polymeric material that is allowed to flow through the analyzer at a flow rate of one milliliter per minute (plus or minus five percent). An example of a suitable analyzer is a Pacific Instruments ABS2 analyzer.

The removal of particulate impurities from a solution of poly(arylene ether), poly(alkenyl aromatic), or a combination of the foregoing may be accomplished by using any presently known filtration system or device. Preferably, the solutions are filtered more than once through filtration systems comprising the same or varying filter material types, filter pore sizes, and filter geometries to obtain suitably clean polymeric material for a particular application. The same or different filtration system may be used for the methods comprising multiple filtration steps.

In one embodiment, a solution of poly(arylene ether) and solvent is filtered in the absence of poly(alkenyl aromatic). In another embodiment, the solution to be filtered comprises poly(arylene ether), poly(alkenyl aromatic), and solvent. The form of poly(arylene ether) or poly(alkenyl aromatic) to prepare the solution may be in any form, preferably as a powder, flake, or pellet. Additionally, the poly(arylene ether) and/or poly(alkenyl aromatic) source to be used to prepare the solutions may be a direct product feed stream from a reactor or reaction vessel.

To form the solution to be filtered, the poly(arylene ether) and/or poly(alkenyl aromatic) is combined with an appropriate solvent with optional heating. The solution prepared may be of any percent weight solids level of poly(arylene ether) and/or poly(alkenyl aromatic) to allow efficient filtration based on the particular filtration system used. Suitable solutions may have a percent weight solids of about 1 to about 99 weight percent solids based on the total of polymeric material and solvent. Within this range a weight percent solids of less than or equal to about 90 may be employed, with less than or equal to about 80 preferred, and less than or equal to about 70 weight percent more preferred. Also within this range a weight percent solids of greater than or equal to about 30 may be used, with greater than or equal to about 40 preferred, and greater than or equal to about 50 more preferred.

The solution to be filtered may be heated prior to and/or during the filtration step. Suitable temperatures of the solutions prior to and/or during the filtration step may be of about 50° C. to about 250° C. Within this range, a temperature of less than or equal to about 210° C. may be employed, with less than or equal to about 190° C. preferred, and less than or equal to about 180° C. more preferred. Also within this range, a temperature of greater than or equal to about 100° C. may be employed, with greater than or equal to about 130° C. preferred, and greater than or equal to about 160° C. more preferred.

Suitable temperatures of the solutions prior to and/or during the filtration step may be of about 100° C. to about 170° C. for the case when ortho-dichlorobenzene solvent is used, and the solution is filtered at atmospheric pressure. Within this range, a temperature of less than or equal to about 170° C. may be employed, with less than or equal to about 160° C. preferred, and less than or equal to about 150° C. more preferred. Also within this range, a temperature of greater than or equal to about 100° C. may be employed, with greater than or equal to about 120° C. preferred, and greater than or equal to about 130° C. more preferred.

In one embodiment, the solution to be filtered is superheated. The term superheated is inclusive of heating the solution to a temperature greater than the boiling point of the solvent at atmospheric pressure. In this embodiment, the temperature of the superheated solution may be about 2° C. to about 200° C. greater than the boiling point of the solvent at atmospheric pressure. In instances where there are multiple solvents present, the solution is superheated with respect to at least one of the solvent components. Superheating may be achieved by heating the solution under pressure. In another embodiment, superheating may be accomplished by applying vacuum to the solution so the surrounding pressure is lower than the vapor pressure of the solvent in the solution. In this instance the solution may said to be superheated even though the solution is at a temperature below the boiling point of the solvent at atmospheric pressure. An advantage of superheating the solution is the convenient and expeditious removal of the solvent to result in the isolated polymeric material.

The filtration of the solutions and/or isolation of the polymeric material are preferably performed under an inert atmosphere, such as nitrogen, to prevent oxidative degradation processes in the polymeric material at the elevated temperatures of these operations.

Suitable filtration systems include filters made from a variety of materials such as, for example, sintered-metal, cloth, polymeric fiber, natural fiber, paper, metal mesh, pulp, ceramic, or a combination of the foregoing materials, and the like. Particularly useful filters are sintered metal filters exhibiting high tortuosity, including the filters prepared by PALL Corporation.

The geometry of the filter may be cone, pleated, candle, stack, flat, wraparound, or a combination of the foregoing, and the like.

The pore size of the filter may be of any size in the range of 0.01 micrometers to 100 micrometers, or greater. Within this range, a pore size of less than or equal to about 50 micrometers can be employed, with less than or equal to about 20 micrometers preferred, and less than or equal to about 15 micrometers more preferred. Also preferred within this range is a pore size of greater than or equal to about 0.1 micrometer, with greater than or equal to about 3 micrometers more preferred, and greater than or equal to about 5 micrometers especially preferred.

Suitable filtration processes may include gravity filtration, pressure filtration, vacuum filtration, batch filtration, continuous filtration, or a combination of the foregoing filtration methods, and the like.

Any number of filtration systems may be used for the method. A single filtration system may be used or two or more in series or in parallel.

The polymeric material obtained is preferably substantially free of visible particulate impurities and/or substantially free of particulate impurities greater than about 15 micrometers.

In another embodiment, a melt of a blend comprising poly(arylene ether) and poly(alkenyl aromatic) may be melt filtered to result in a material substantially free of particulate impurities. The residence time of the melt in the extruder should be controlled to minimize decomposition of the polymeric material, especially the poly(arylene ether) component. Poly(arylene ether)s are known to oxidize and form gels if maintained at high temperatures. These resins may also form carbonized “black specks” or degrade in color (darken) if processed at high temperatures. Therefore, it is preferable to minimize the residence time of the melt by choice of extruder screw design and by controlling the screw speed and feed rate. A residence time of less than or equal to about 5 minutes may be employed, with less than or equal to about 2 minutes preferred, and less than or equal to about 1 minute more preferred.

It is also preferable to minimize the residence time of the melt through the melt filtration system. The melt filtration system may be designed to provide short residence times based on the choice of the surface area of the filter and volume of the melt filtration housing. A higher filter surface area and a smaller housing volume can provide shorter residence times.

The melt filtration system of the extruder is preferably located at the terminal barrel of the extruder, and more preferably at the die head of the extruder. The extruder may comprise a single melt filtration system or multiple melt filtration systems.

Any type of extruder that is capable of providing a homogenous melt of poly(arylene ether), poly(alkenyl aromatic) and/or additional resins and additives, may be used. Useful types of extruders include, for example, a twin screw counter-rotating extruder, a twin screw co-rotating extruder, a single screw extruder, a single screw reciprocating extruder, a kneader, a compounder-extruder, a ring extruder, a combination of the foregoing, and the like. Preferably a single extruder may be used, but multiple extruders may be employed. Ring extruders typically comprise a ring of three to twelve small screws or grooved rolls around a static rod or core. The screws corotate and intermesh on two sides providing good dispersive and distributive mixing as well as the ability to control the residence time of the resin in the extruder. The intermeshing design also provides two clean wipes to the screw's shear, mixing, and kneading elements. Suitable ring extruders are those available from 3+ Extruder GmbH in Germany.

When preparing blends of poly(arylene ether) solvent, monomers, and other low molecular weight materials are removed from the extruder through the vent system. A particularly useful process to improve the removal of volatile substances from poly(arylene ether) or poly(arylene ether) resin blends includes steam stripping as describe in U.S. Pat. No. 5,204,410 to Banevicius et al., U.S. Pat. No. 5,102,591 to Hasson et al., U.S. Pat. No. 4,994,217 to Banevicius, and 4,992, 222 to Banevicius et al. Steam stripping is typically performed in an extruder comprising ports for the injection of water or steam and sufficient vacuum vent capability to remove the stripped volatiles and water. Water or steam are the preferred stripping agents, and the proportion employed is up to about 15 percent by weight of the polymer composition, to be divided equally, or unequally, among the two or more injection ports located along the length of the extruder barrel. The preferred proportion is from about 0.25 to about 15 weight percent, since an amount within this range is generally very effective for removal of volatiles without burdening the vacuum system. Most preferred is from 0.5 to about 5 weight percent.

Also contemplated are extruders comprising one or more side feeders along the extruder barrel suitable to feed additional components to the melt. Additional components include additional resins, functionalizing agents and/or additives.

The extruder is preferably run at temperatures suitable to produce an intimate blend of the components that compose the melt, but low enough to minimize decomposition of the melt. A range of extruder temperatures that may be employed are of about 260° C. to about 380° C. Within this range a temperature of less than or equal to about 340° C. may be employed, and less than or equal to about 320° C. more preferred. Also within this range a temperature of greater than or equal to about 280° C. may be employed, and greater than or equal to about 290° C. preferred.

When a twin-screw extruder is employed, the extruder operation may be defined by a specific throughput rate of about 0.5 kilogram per hour per cubic centimeter (kg/hr/cm³) to about 8.0 kg/hr/cm³. The specific throughput rate is defined as the throughput rate of the melt divided by the diameter³ of the extruder barrel. Within this range a specific throughput rate of less than or equal to about 7.5 kg/hr/cm³ may be employed, and less than or equal to about 7 kg/hr/cm³ preferred. Also within this range a throughput rate of greater than or equal to about 3 kg/hr/cm³ may be employed, and greater than or equal to about 5 kg/hr/cm³ preferred.

In one embodiment, a melt pump or gear pump is used in combination with the extruder to provide sufficient rate and pressure of a flow of melt through the melt filtration system. The melt pump also provides the capability to control and maintain an even flow of melt through the extruder system resulting in a uniform polymeric material.

In one embodiment, the poly(arylene ether), poly(alkylene aromatic), and optional additional components may be compounded prior to the melt blending step. Any known equipment capable of compounding the components may be used, for example, mixers capable of applying shear to the components, conical screw mixers, V-blenders, twin screw compounders, Henschel mixers, and the like. Preferred compounders include counter-rotating extruders or counter-rotating conical extruders.

Any suitable melt filtration system or device that can remove particulate impurities from a melt comprising poly(arylene ether), poly(alkenyl aromatic), or a combination of the two, may be used. Preferably, the melt is filtered through a single melt filtration system, although multiple melt filtration systems are contemplated.

Suitable melt filtration systems include filters made from a variety of materials such as, for example, sintered-metal, metal mesh or screen, fiber metal felt, ceramic, or a combination of the foregoing materials, and the like. Particularly useful filters are sintered metal filters exhibiting high tortuosity, including the filters prepared by PALL Corporation.

Any geometry of melt filter may be used including, for example, cone, pleated, candle, stack, flat, wraparound, screens, a combination of the foregoing, and the like.

The melt filtration system may include a continuous screen changing filter or batch filters. For example, continuous screen changing filters may include a ribbon of screen filter that is slowly passed before the path of a melt flow in an extruder. The filter collects particulate impurities within the melt which are then carried out of the extruder with the filter ribbon as it is continuously renewed with a new section of ribbon.

The pore size of the melt filter may be of any size ranging from about 0.5 micrometer to about 200 micrometers. Within this range, a pore size of less than or equal to about 100 micrometers can be employed, with less than or equal to about 50 micrometers preferred, and less than or equal to about 20 micrometers more preferred. Also within this range a pore size of greater than or equal to about 1 micrometer may be used, with greater than or equal to about 7 micrometers preferred, and greater than or equal to about 15 micrometers more preferred.

The temperature of the melt filtration system is preferably of about 260° C. to about 380° C. Within this range a temperature of less than or equal to about 340° C. may be employed, and less than or equal to about 320° C. more preferred. Also within this range a temperature of greater than or equal to about 280° C. may be employed, and greater than or equal to about 290° C. preferred.

The melt filtered polymeric material obtained is preferably substantially free of visible particulates. In one embodiment, the melt filtered polymeric material is substantially free of particulate impurities greater than about 10 micrometers, meaning that of a forty gram sample of polymeric material dissolved in 400 milliliters of CHCl₃, the number of particulates per gram having a size of about 10 micrometers is less than 200, as measured by a Pacific Instruments ABS2 analyzer based on the average of five samples of twenty milliliter quantities of the dissolved polymeric material that is allowed to flow through the analyzer at a flow rate of one milliliter per minute (plus or minus five percent).

When molded, polymeric material often shrinks upon cooling, yet gels and other particulate impurities do not shrink or shrink at different rates than that of the polymeric material. These impurities, if located at the surface. of the molded substrate, may contribute to surface imperfections and disrupt the groove and land pattern of the data disk substrate. As the amount and type of particulate impurities in the substrate material may significantly affect the surface quality of the substrate and hence the read/write accuracy of the medium, it is desirable to use a substrate material having a minimum of impurities. In one embodiment, the substrate is prepared from a blend of poly(arylene ether) and poly(alkenyl aromatic) substantially free of visible particulate impurities.

In a further embodiment, the substrate is prepared from a blend of poly(arylene ether) and poly(alkenyl aromatic) substantially free of particulate impurities having sizes greater than or equal to about 50 percent of the narrowest thickness of the disk substrate. As defined herein, the narrowest thickness is measured from the surface comprising the patterned side (groove and land surface) to the surface opposite to the patterned side. Within this range, the blend is substantially free of particulate impurities having sizes of greater than or equal to about 25 percent of the narrowest thickness of the disk substrate, preferably substantially free of particulate impurities having sizes greater than or equal to about 5 percent of the narrowest thickness of the disk substrate, more preferably substantially free of particulate impurities having sizes greater than or equal to about 1 percent of the narrowest thickness of the disk substrate, and yet more preferably substantially free of particulate impurities having sizes greater than or equal to about 0.1 percent of the narrowest thickness of the disk substrate. For example, a disk substrate having a minimum cross-sectional height of 1 millimeter or 1000 micrometers may be prepared from a blend substantially free of particulates having sizes greater than or equal to about 500 micrometers, preferably substantially free of particulates having sizes greater than or equal to about 250 micrometers, more preferably substantially free of particulates having sizes greater than or equal to about 50 micrometers, even more preferably substantially free of particulates having sizes greater than or equal to about 10 micrometers, and yet more preferably substantially free of particulates having sizes greater than or equal to about 1 micrometer.

The data disk assembly generally comprises an optical layer in addition to the substrate. Typically, the optical layer comprises a thermoplastic polycarbonate. As used herein, the terms “polycarbonate” includes compositions having structural units of the formula (III): 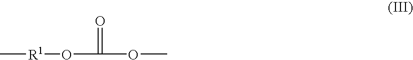
in which at least about 60 percent of the total number of R² groups are aromatic organic radicals and the balance thereof are aliphatic, alicyclic, or aromatic radicals. Preferably, R² is an aromatic organic radical and, more preferably, a radical of the formula (IV):
—A¹—Y¹—A²— (IV)
wherein each of A¹ and A² is a monocyclic divalent aryl radical and Y¹ is a bridging radical having zero, one, or two atoms which separate A¹ from A². In an exemplary embodiment, one atom separates A¹ from A². Illustrative, non-limiting examples of radicals of this type are —O—, —S—, —S(O)—, —S(O₂)—, —C(O)—, methylene, cyclohexyl-methylene, 2-[2,2,1]-bicycloheptylidene, ethylidene, isopropylidene, neopentylidene, cyclohexylidene, cyclopentadecylidene, cyclododecylidene, adamantylidene, and the like. In another embodiment, zero atoms separate A¹ from A², with an illustrative example being biphenol. The bridging radical y¹ can be a hydrocarbon group or a saturated hydrocarbon group, for example, methylene, cyclohexylidene or isopropylidene or a heteroatom such as —O— or —S—.

Polycarbonates may be, produced by the reaction of dihydroxy compounds in which only one atom separates A¹ and A². As used herein, the term “dihydroxy compound” includes, for example, bisphenol compounds having the general formula (V) as follows: 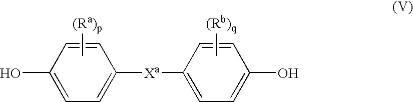
wherein R^{a} and R^{b} each independently represent hydrogen, a halogen atom, or a monovalent hydrocarbon group; p and q are each independently integers in a range between 0 and about 4; and X^{a} represents one of the groups of formula (VI): 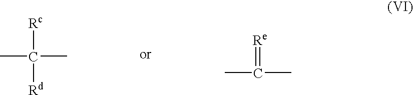
wherein R^{c} and R^{d} each independently represent a hydrogen atom or a monovalent linear or cyclic hydrocarbon group, and R^{e} is a divalent hydrocarbon group.

Some illustrative, non-limiting examples of suitable dihydroxy compounds include dihydric phenols and the dihydroxy-substituted aromatic hydrocarbons such as those disclosed by name or formula (generic or specific) in U.S. Pat. No. 4,217,438 to Brunelle et al. A nonexclusive list of specific examples of the types of bisphenol compounds that may be represented by formula (IV) includes the following: 1,1-bis(4-hydroxyphenyl) methane; 1,1-bis(4-hydroxyphenyl) ethane; 2,2-bis(4-hydroxyphenyl) propane (hereinafter “bisphenol-A” or “BPA”); 2,2-bis(4-hydroxyphenyl) butane; 2,2-bis(4-hydroxyphenyl) octane; 1,1-bis(4-hydroxyphenyl) propane; 1,1-bis(4-hydroxyphenyl) n-butane; bis(4-hydroxyphenyl) phenylmethane; 2,2-bis(4-hydroxy-1-methylphenyl) propane; 1,1-bis(4-hydroxy-t-butylphenyl) propane; bis(hydroxyaryl) alkanes such as 2,2-bis(4-hydroxy-3-bromophenyl) propane; 1,1-bis(4-hydroxyphenyl) cyclopentane; 4,4′-biphenol; and bis(hydroxyaryl) cycloalkanes such as 1,1-bis(4-hydroxyphenyl) cyclohexane; and the like as well as combinations comprising at least one of the foregoing compounds.

It is also possible to employ polycarbonates resulting from the polymerization of two or more different dihydric phenols or a copolymer of a dihydric phenol with a glycol or with a hydroxy- or acid-terminated polyester or with a dibasic acid or with a hydroxy acid or with an aliphatic diacid in the event a carbonate copolymer rather than a homopolymer is desired for use. Generally, useful aliphatic diacids have carbon atoms in a range between about 2 and about 40. A preferred aliphatic diacid is dodecandioic acid.

Polyarylates and polyester-carbonate resins or their blends can also be employed. Branched polycarbonates are also useful, as well as blends of linear polycarbonates and branched polycarbonates. The branched polycarbonates may be prepared by adding a branching agent during polymerization.

These branching agents are well known and may comprise polyfunctional organic compounds containing at least three functional groups which may be hydroxyl, carboxyl, carboxylic anhydride, haloformyl, and mixtures comprising at least one of the foregoing branching agents. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) α,α-dimethyl benzyl)phenol), 4-chloroformyl phthalic anhydride, trimesic acid, benzophenone tetracarboxylic acid, and the like, as well as combinations comprising at least one of the foregoing branching agents. The branching agents may be added at a level in a range between about 0.05 weight percent and about 2.0 weight percent, based upon the total weight of the substrate. Examples of branching agents and procedures for making branched polycarbonates are described in U.S. Pat. Nos. 3,635,895 and 4,001,184 to Scott. All types of polycarbonate end groups are herein contemplated.

Useful polycarbonates are based on bisphenol-A, in which each of A¹ and A² is p-phenylene and Y¹ is isopropylidene. Preferably, the weight average molecular weight of the polycarbonate is in a range between about 5,000 atomic mass units and about 100,000 atomic mass units, more preferably in a range between about 10,000 atomic mass units and about 65,000 atomic mass units, and most preferably in a range between about 15,000 atomic mass units and about 35,000 atomic mass units.

In one embodiment, the optical layer comprises a polycarbonate comprising at least one structural unit of (VII): 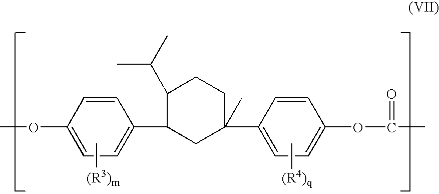
where the three optically active sites of (VII) can be R isomers, S isomers, or combinations thereof; R³, and R⁴ are independently selected from the group consisting of C₁-C₆ alkyl and hydrogen; m is an integer in a range between about 1 and about 4; and q is an integer in a range of about 1 and about 4. Representative units of structure (VII) include residues derived from 1,3-bis(4-hydroxyphenyl)menthane (BHPM) also known as 4,4′-[1-methyl-4-(1-methylethyl)-1,3-cyclohexandiyl]bisphenol or BPT-2. Polymers comprising units of structure (VII) may also be blended with other polycarbonates or poly(alkenyl aromatic) resins, for example, polystyrene.

Both homopolymers and copolymers comprising structural units of (VII) are included herein. Particularly useful copolymers include structural units of (VII) and units derived from the bisphenols of (V). Homopolymers and copolymers of BHPM are especially preferred for use in the optical layer. Copolymers of BHPM and BPA may be used comprising any ratio of BHPM to BPA. For example, a copolymer of BHPM/BPA may comprise greater than or equal to about 90 molar percent (mol %) of BHPM, optionally greater than or equal to about 70 mol % BHPM, further optionally greater than or equal to about 50 mol % BHPM, and yet optionally greater than or equal to about 10 mol % BHPM. Other useful copolymers derived from BHPM in combination with BPA and 4-[1-[3-(4-hydroxyphenyl)-4-methylcyclohexyl]-1-methylethyl] phenol (BPT-1) are described in U.S. Pat. No. 6,492,486 to Mahood.

Typically, the weight average molecular weight of the polycarbonate comprising structural units of (VII) is in a range of about 20,000 and about 100,000.

In one embodiment, the optical layer comprises a solvent cast polycarbonate film from Teijin Chemicals available under the trademark PURE-ACE. The solvent cast polycarbonate film has an absence of foreign substances and a uniform thickness of 50, 70, 100, 120, or 160 micrometers. For example, the 100 micrometer optical isotropic film exhibits a breaking strength in the machine direction (MD) of 86.2 mega Pascals (Mpa) and 83.3 Mpa in the transverse direction (TD); an elongation at break of 173 percent (MD) and 165 percent (TD); and a Young's modulus of 1780 Mpa (MD) and 1790 Mpa (TD). The film exhibits a refractive index of greater than 1.58, transmits greater than 90 percent of light, has a haze of less than or equal to 0.3 percent, and has a glass transition temperature of 160° C.

In one embodiment, the optical layer comprises a blend of different polycarbonates. Blends comprising homopolycarbonates derived from a single dihydroxy compound monomer and copolycarbonates derived from more than one dihydroxy compound monomers and combinations thereof are encompassed.

In one embodiment, the optical layer comprises a polycarbonate or copolycarbonate comprising structural units (VIII) or (IX): 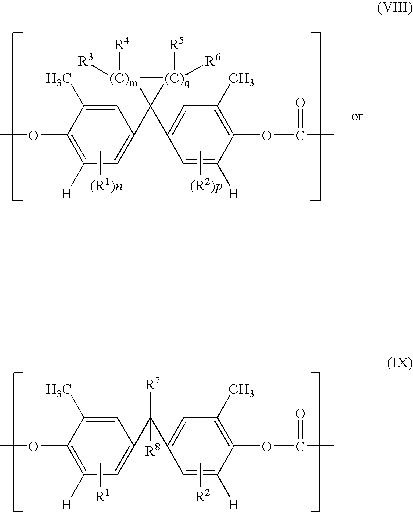
where R¹, R², R³, R⁴, R⁵, and R⁶ are, independently chosen from C₁-C₆ alkyl and hydrogen; R⁷ and R⁸ are, independently, C₁-C₆ alkyl, phenyl, C₁-C₆ alkyl substituted phenyl, or hydrogen; m is an integer of 0 to about 12; q is an integer of 0 to about 12; m+q is an integer of about 4 to about 12; n is an integer of about 1 to about 2; and p is an integer of about 1 to about 2.

Representative units of structure (VIII) include, for example, to residues of 1,1-bis(4-hydroxy-3-methylphenyl)cyclohexane (DMBPC); 1,1-bis(4-hydroxy-3-methylphenyl)cyclopentane; 1,1-bis(4-hydroxy-3-meihylphenyl)cycloheptane; 1,1-bis(4-hydroxy-3-methylphenyl)-3,3,5-trimethylcyclohexane (DMBPI); and mixtures comprising at least one of the foregoing units.

Representative units of structure (IX) include, for example, residues of 2,2-bis(4-hydroxy-3-methyl)propane (DMBPA); and 4,4′-(1-phenylethylidene)bis(2-methylphenol) (DMbisAP).

In an even further embodiment, the optical layer can comprise polycarbonate or copolycarbonate comprising the structural units (X): 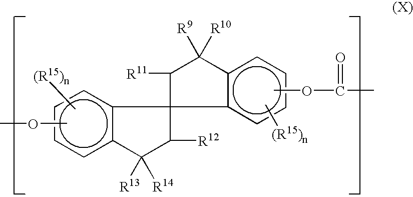
wherein R⁹, R¹⁰, R¹³ and R¹⁴ are independently C₁-C₆ alkyl, R¹¹ and R¹² are independently H or C₁-C₅ alkyl, each R¹⁵ is independently selected from H and C₁-C₃ alkyl and each n is independently selected from 0, 1 and 2.

Representative units of structure (X) include, for example, 6,6′-dihydroxy-3,3,3′,3′-tetramethyl spirobiindane (SBI); 6,6′-dihydroxy-3,3,5,3′,3′,5′-hexamethyl spirobiindane; 6,6′-dihydroxy-3,3,5,7,3′,3′,5′,7′-octamethylspirobiindane; 5,5′-diethyl-6,6′-dihydroxy 3,3,3′,3′-tetramethylspirobiindane, and mixtures comprising at least one of the foregoing units.

The polycarbonate composition may also include various additives ordinarily incorporated in resin compositions of this type as long as the optical properties of the polycarbonate is not compromised. Such additives include, for example, heat stabilizers; antioxidants; light stabilizers; plasticizers; antistatic agents; mold releasing agents; additional resins; and the like, as well as combinations comprising at least one of the foregoing additives.

Another suitable material for the optical layer includes silicone materials such as a silicone hard coat. In one embodiment, the silicone hard coat comprises a plasma-polymerized organosilicone. A plasma-polymerized organosilicone, sometimes called a hydroxy silicon carbide or silicon oxy carbon coating, is a product of plasma deposition of a silicon precursor having the formula 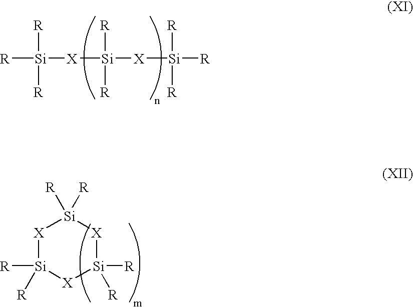
wherein each R is independently hydrogen, C₁-C₆ alkyl, C₂-C₆ alkenyl, C₃-C₆ alkenyl alkyl, C₆-C₁₈ aryl, or the like; n is 0 to about 100; m is 1 to about 100; and X is —O— or —NH—.

Preferred organosilicone compounds include 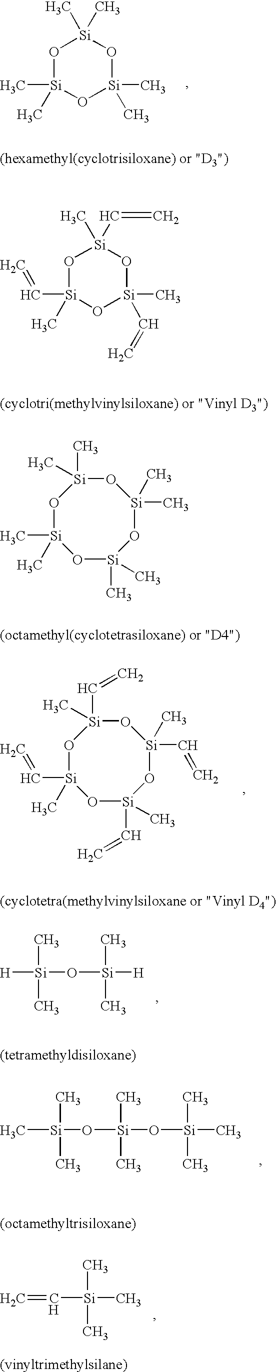 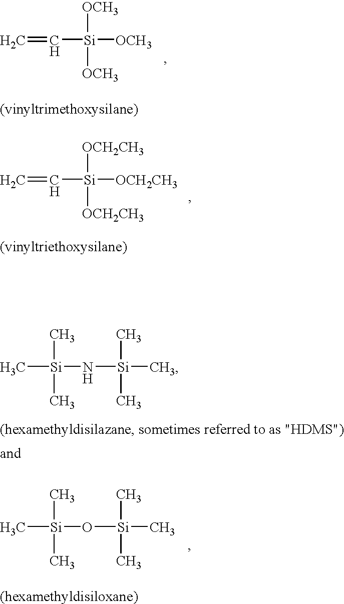
and the like, and mixtures thereof.

Plasma polymerization of the organosilicone may take place in the presence of a small amount of oxygen that may be incorporated into the coating. The plasma-polymerized silicone hard coat optical layer can be formed from a variety of plasma deposition techniques including plasma assisted or enhanced chemical vapor deposition (PECVD, PACVD) using plasma sources of radio frequency (RF), microwave (MW), inductively coupled plasma (ICP), electron cyclotron resonance (ECR), hollow cathode, thermal plasma, expanding thermal plasma (ETP), and plasma arcs or jets. In a preferred embodiment, the silicone hard coat optical layer is deposited by ETP as described in patents U.S. Pat. No. 6,420,032 to lacovangelo and U.S. Pat. No. 6,397,776 to Yang et al. Suitable silicone hard coats are available from GE Silicones under the tradenames AS4000, PHC587, UVHC3000, and UVHC8558.

The optical layer preferably has optical properties such as in-plane retardation of 20 nanometers (nm) and lower. “In-plane retardations” as used herein refers to a measure of the birefringence in the optical layer. The optical layer also preferably has low thickness non-uniformity and low surface roughness. For a 100 micrometer optical layer, thickness uniformity at length scales longer than 2 centimeters (cm) is on the order of less than 2 micrometers and the surface roughness at the 1 millimeter (mm) length scale is on the order of 40 nm or less. The common processes that are utilized to produce the optical layer with these specifications are, for example, solution casting, extrusion casting, extrusion calendaring, spin coating, and injection molding. Preferably, solution casting is used.

Data storage media can be produced by first forming the substrate material using a conventional reaction vessel capable of adequately mixing various precursors, such as a single or twin-screw extruder, kneader, blender, or the like. The extruder should be maintained at a sufficiently high temperature to melt the substrate material precursors without causing decomposition thereof. Similarly, the residence time, temperature, and shear rate in the extruder should be controlled to minimize decomposition. Average residence times of up to about 2 minutes (min) or more can be employed, with up to about 1.5 min preferred, and up to about 1 min especially preferred. Prior to extrusion into the desired form (typically pellets, sheet, web, or the like), the mixture can optionally be filtered, such as by melt filtering, the use of a screen pack, or combinations thereof, or the like, to remove undesirable contaminants or decomposition products. Useful methods to prepare the prepare the polymeric material described herein is disclosed in Application Serial No. ______, attorney docket no. 126750-1 entitled “Methods of Preparing a Polymeric Material”, commonly owned and copending with the present application and Application Ser. No. ______, attorney docket no. 131982-1 entitled “Methods of Preparing a Polymeric Material”, commonly owned and copending with the present application.

The data storage medium further comprises a data layer made of any material capable of storing retrievable data. The data or information which is to be stored on the data storage medium can be imprinted directly onto the surface of the data layer, or stored in a photo-, thermal-, or magnetically-definable medium which has been deposited onto the surface of the substrate layer. Suitable material for the data layer include, for example, oxides (e.g., silicone oxide), rare earth element-transition metal alloys, nickel, cobalt, chromium, tantalum, platinum, terbium, gadolinium, iron, boron, organic dyes (e.g., cyanine or phthalocyanine type dyes), inorganic phase change compounds (e.g., GeTeSb, TeSeSn, or InAgSb), and any alloys or combinations comprising at least one of the foregoing. Exemplary phase change compounds include the phase-change chalcogenide alloys available from Energy Conversion Device, Inc. (ECD). The thickness of a typical data layer can be up to about 1000 Angstroms. In one embodiment, the thickness of the data layer is up to about 300 Angstroms.

The data storage layer may be applied to the disk substrate by a sputtering process, electroplating, or coating techniques (spin coating, spray coating, vapor deposition, screen printing, painting, dipping, sputtering, vacuum deposition, electrodeposition, meniscus coating, and the like).

The data storage medium may optionally comprise a reflective metal layer preferably of a thickness that is sufficient to reflect an amount of energy sufficient to enable data retrieval. Typically, a reflective layer has a thickness up to about 700 Angstroms. In one embodiment, the thickness of the reflective layer is in a range of about 300 Angstroms and about 600 Angstroms. Suitable reflective layers include, for example, aluminum, silver, gold, titanium, and alloys and mixtures comprising at least one of the foregoing. In addition to the data storage layer, dielectric layer, and reflective layer, the assembly may comprise other layers such as a protective layer, a lubrication layer, an adhesive layer, and others. Suitable lubricant layers include, for example, fluoro compounds such as fluoro oils and greases.

The data disk media may optionally comprise a dielectric layer, which may be disposed on one or both sides of the data layer and are often employed as heat controllers. The dielectric layer can typically have a thickness of up to or exceeding about 1,000 Angstroms and as low as about 200 Angstroms, although other thickness may be used. Possible dielectric layers include nitrides (e.g., silicon nitride, aluminum nitride, and others); oxides (e.g., aluminum oxide); carbides (e.g., silicon carbide); and alloys and combinations comprising at least one of the foregoing, among other materials compatible within the environment and preferably, not reactive with the surrounding layers.

Optionally disposed between the optical layer and the data storage layer, and/or between other layers, is an adhesive layer that can, for example, adhere the optical layer to the other layers supported by the substrate. The adhesive layer can also be employed to enhance the dampening of the disc, with the thickness and nature of the adhesive determining the amount of dampening provided by the layer. The adhesive layer, which can have a thickness of up to about 50 micrometers or so, with a thickness in a range of about 1 micrometers and about 30 micrometers preferred, can comprise rubber based or elastomeric thermosets, flexible thermoplastics, and the like. When used in optical or magneto-optical media, the adhesive is preferably one that provides suitable optical properties required for the application. Typical adhesives are rubber-based or rubber-like materials, such as natural rubber, silicone rubber, or acrylic ester polymers, and the like. Non-rigid polymeric adhesives such as those based on rubber or acrylic polymers and the like have some of the properties of elastomers, such as flexibility, creep resistance, resilience, and elasticity, and do provide useful dampening to enhance the quality of playback of the data storage disc. The chemistry of non-rigid polymeric adhesives is diverse, and includes polymers of the types of materials described herein as elastomers and rubbers, as flexible thermoplastics, and as thermoplastic elastomers. Suitable examples of such adhesives include polyisoprene, styrene butadiene rubber, ethylene propylene rubber, fluoro vinyl methyl siloxane, chlorinated isobutene-isoprene, chloroprene, chlorinated polyethylene, chlorosulfonated polyethylene, butyl acrylate, expanded polystyrene, expanded polyethylene, expanded polypropylene, foamed polyurethane, plasticized polyvinyl chloride, dimethyl silicone polymers, methyl vinyl silicone, polyvinyl acetate, and the like, as well as compositions comprising at least one of the foregoing adhesives. This layer may also comprise any combination comprising at least one of the above adhesives. Typically pressure sensitive adhesives are preferred for use in data storage disc applications. The adhesive layer may be added to the data storage disc by methods such as vapor deposition, spin casting, solution deposition, injection molding, extrusion molding, and the like.

Optionally, a high modulus layer may also be present in the data storage medium and is typically disposed on the surface of the optical layer opposite to the substrate. As used herein, the term “high modulus” refers to a tensile modulus typically greater than about 1 Gigapascal (Gpa). In one embodiment, a suitable high modulus layer typically comprises a thermoset polymer, which can be cured thermally, cured by ultraviolet (UV) radiation, or cured by any method commonly known to those skilled in the art. In another embodiment, the high modulus layer comprises a thermoplastic polymer. In yet another embodiment, the high modulus layer comprises a combination of a thermoset polymer and a thermoplastic polymer. Typically, the high modulus layer is applied to the storage medium via a spin-coating process, however, any method known to those skilled in the art such as, for example, spray deposition, sputtering, and plasma deposition can be used. Typically, the high modulus layer has a thickness in a range of about 0.5 micrometer and about 30 micrometers.

Useful thermoset polymers for use in the high modulus layer include, for example, polymers derived from silicones, functionalized polyarylene ethers, epoxys, cyanate esters, unsaturated polyesters, multifunctional allylic materials, diallylphthalate, acrylics, alkyds, phenol-formaldehyde, novolacs, resoles, bismaleimides, melamine-formaldehyde, urea-formaldehyde, benzocyclobutanes, hydroxymethylfurans, isocyanates, and any combinations thereof. Useful silicones include the silicone hard coats available from GE Silicone. In one embodiment, the thermoset polymer further comprises at least one thermoplastic polymer, such as, for example, polycarbonates, polyestercarbonates, poly(arylene ether)s, polyphenylene sulfides, polysulfones, polyetherimides, polyethersulfones, polyetherketones, polyesters, copolycarbonate ester, and the like. Typically, the high modulus layer is a copolycarbonate ester. The thermoplastic polymer is typically combined with a thermoset monomer mixture before curing of the thermoset.

The medium may be of any shape that allows for the medium to be affixed to a spindle and the data read while the medium is spun about the spindle. Most commonly, the medium is a disk shape having a hole in the center for affixation to a spindle, and an outside diameter, typically circular. Other shapes may also be used rather than circular, including, for example, square, star, octagonal, hexagonal, and the like. Currently, the dimensions of the storage medium are specified by the industry to enable their use in presently available data storage medium reading and writing devices. The data storage medium typically has an inner diameter of about 15 mm to about 40 mm and an outer diameter of about 65 mm to about 130 mm. Other diameters contemplated include an inner diameter of about 1 mm to about 100 mm, more preferably about 5 mm to about 60 mm. Other outer diameters include about 5 mm to about 300 mm, more preferably about 50 mm to about 200 mm. Typical substrate thicknesses are about 0.2 mm to about 2.5 mm. Within this range the substrate thickness may be greater than or equal to about 0.5 mm and preferably greater than or equal to about 0.8 mm. Also within this range, the substrate thickness may be less than or equal to about 1.2 mm, and preferably less than or equal to about 1.0 mm. Other diameters and thickness may be employed to obtain a stiffer architecture if necessary.

The storage medium described herein can be employed in conventional optical, magneto-optical, and magnetic systems, as well as in advanced systems requiring higher quality storage medium, higher areal density, or any combinations thereof. During use, the storage medium is disposed in relation to a read/write device such that energy (for instance, magnetic, light, electric, or any combination thereof) contacts with the data layer in the form of an energy field incident on the data storage medium. The energy field contacts the data layer disposed on the storage medium. The energy field causes a physical or chemical change in the storage medium so as to record the incidence of the energy at that point on a data layer. For example, an incident magnetic field might change the orientation of magnetic dormains within a data layer or an incident light beam could cause a phase transformation where the light heats the point of contact on a data layer.

In a preferred embodiment, the data storage disk is prepared from a substrate comprising lands and grooves and an appropriate data layer capable of being read using a laser having a wavelength of less than about 700 nanometers, preferably less than about 420 nanometers. For instance, the blue laser used in DVR devices currently employs a laser having a wavelength of about 405 nanometers. Also, the data storage disk is prepared from a substrate comprising lands and grooves and an appropriate data layer capable of being read using a numerical aperture lens of greater than or equal to about 0.6 and preferably greater than or equal to about 0.8.

To achieve high areal density storage media using decreasing laser wavelength and/or increasing numerical aperture the land and groove feature dimensions have become increasingly smaller. Current technology employs a land and groove pattern that spirals in the form of a track from the center of the disk outward. In one embodiment, the substrate may have lands and grooves comprising a pitch of about 0.05 to about 0.7 micrometer. As defined herein, the pitch is measured from the center of the groove to the center of an adjacent groove. Within this range the pitch may be greater than or equal to about 0.2 micrometer and preferably greater than or equal to about 0.25 micrometer. Also within this range, the pitch may be less than or equal to about 0.4 micrometer and preferably less than or equal to about 0.35 micrometer.

The dimension of the lands and grooves may be selected to provide the highest areal density depending upon the method of retrieving the data. In one embodiment, the width of the lands may be of about 10 to about 200 nanometers. Within this range, the width of the lands may be greater than or equal to about 25 nanometers and preferably greater than or equal to about 45 nanometers. Also within this range, the width of the lands may be less than or equal to about 100 and preferably less than or equal to about 80 nanometers. The height of the lands may range from about 10 to about 100 nanometers and more preferably greater than or equal to about 45 nanometers and less than or equal to about 80 nanometers.

In one embodiment, the width of the grooves may be of about 10 to about 200 nanometers. Within this range, the width of the grooves may be greater than or equal to about 25 nanometers and preferably greater than or equal to about 45 nanometers. Also within this range, the width of the grooves may be less than or equal to about 100 and preferably less than or equal to about 80 nanometers. The height of the grooves may range from about 10 to about 100 nanometers and more preferably greater than or equal to about 45 nanometers and less than or equal to about 80 nanometers.

Typically the data storage medium comprises a storage capacity of greater than about 22 gigabytes, preferably greater than about 25 gigabytes, and more preferably greater than about 27 gigabytes per disk side. Accordingly, double-sided disks may comprise a storage capacity of greater than about 44 gigabytes, preferably greater than about 50 gigabytes, and more preferably greater than about 54 gigabytes.

The transfer rate of the data storage medium typically is greater than about 25 megabytes per second, preferably greater than about 30 megabytes per second, and even more preferably greater than about 35 megabytes per second.

Numerous methods may be employed to produce the storage medium including, for example, injection molding, foaming processes, sputtering, plasma vapor deposition, vacuum deposition, electrodeposition, spin coating, solvent casting, spray coating, meniscus coating, data stamping, embossing, surface polishing, fixturing, laminating, rotary molding, two shot molding, coinjection, over-molding of film, microcellular molding, and combinations thereof. In one embodiment, the technique employed enables in situ production of the substrate having the desired features, for example, lands and grooves. One such process comprises an injection molding-compression technique where a mold is filled with a molten polymer, such as a poly(arylene ether)/poly(alkenyl aromatic) blend as defined herein. The mold may contain a preform or insert. The polymer system is cooled and, while still in at least partially molten state, compressed to imprint the desired surface features, for example, pits and grooves, arranged in spiral concentric or other orientation, onto the desired portions of the substrate, i.e., one or both sides in the desired areas. The substrate is then cooled to room temperature. Once the substrate has been produced, additional processing, such as electroplating, coating techniques (e.g., spin coating, spray coating, vapor deposition, screen printing, painting, dipping, and the like), lamination, sputtering, and the like, as well as combinations comprising at least one of the foregoing processing techniques, may be employed to dispose desired layers on the substrate.

In one embodiment, the substrate layer is prepared by injection molding a blend of poly(arylene ether) and poly(alkenyl aromatic) to form a disk substrate having reduced molded in stresses through the control of the injection molding parameters. Reduced molded in stresses in the substrate provides a disk assembly having increased dimensional stability, thereby exhibiting minimal tilt when the assembly is exposed to elevated temperatures. When injection molding a blend of poly(arylene ether) and poly(alkenyl aromatic), a melt temperature of about 330 to about 370° C. may be used. Within this range a melt temperature of greater than or equal to about 340° C. is preferred, with greater than or equal to about 350° C. more preferred. Also within this range a melt temperature of less than or equal to about 360° C. is preferred, with less than or equal to about 355° C. more preferred.

Also within the previous embodiment, a mold temperature of about 90 to about 130° C. may be used. Within this range a mold temperature of greater than or equal to about 100° C. may be used, with greater than or equal to about 110° C. preferred, and with greater than or equal to about 115° C. more preferred. Also within this range a mold temperature of less than or equal to about 125° C. is preferred, with less than or equal to about 120° C. more preferred. A clamp tonnage of greater than or equal to about 12 tons may be used, preferably greater than on equal to about 20 preferred and greater than or equal to about 35 more preferred.

When injection molding to prepare the substrate, a cool time of about 1 to about 35 seconds may be used. Within this range a cool time of greater than or equal to about 5 seconds is preferred, with greater than or equal to about 7 seconds more preferred, and greater than or equal to about 12 seconds even more preferred. Also within this range a cool time of less than or equal to about 25 seconds may be used, with less than or equal to about 20 seconds preferred, and less than or equal to about 15 seconds more preferred.

Futhermore, when injection molding to prepare the substrate a hold pressure of about 1 to about 40 kgf/cm² may be used. Within this range a hold pressure of greater than or equal to about 5 kgf/cm² is preferred, with greater than or equal to about 10 kgf/cm² more preferred, and greater than or equal to about 15 kgf/cm² even more preferred. Also within this range a hold pressure of less than or equal to about 35 kgf/cm² may be used, with less than or equal to about 30 kgf/cm² preferred, and less than or equal to about 25 kgf/cm² more preferred.

It is desirable for substrate to exhibit a percent feature replication of the mold features of greater than or equal to about 90 percent, with greater than or equal to about 92 percent preferred, with greater than or equal to about 94 percent more preferred, greater than or equal to about 95 percent yet more preferred, and greater than or equal to about 98 percent even yet more preferred.

It is also desirable that a data disk assembly fabricated from the substrate described herein exhibits a radial tilt change value after 96 hours at 80° C. of less than or equal to about 0.5 degree measured at a radius of 55 millimeters. Within this range a radial tilt change value after 96 hours at 80° C. of less than or equal to about 0.35 degree is preferred, with less than or equal to about 0.25 degree more preferred, and less than or equal to about 0.15 degree even more preferred.

In one embodiment, a data storage medium comprises a substrate layer comprising a blend of poly(arylene ether) resin and poly(alkenyl aromatic) resin; wherein the substrate layer comprises a surface comprising lands and grooves, wherein the lands and grooves comprise a pitch of about 0.05 to about 0.7 micrometer, preferably a pitch of about 0.2 to about 0.4 micrometer, and more preferably a pitch of about 0.25 to about 0.35 micrometer.

In another embodiment, a data storage medium comprises a substrate layer comprising a blend of poly(arylene ether) resin and poly(alkenyl aromatic) resin; wherein the substrate layer comprises a surface comprising lands and grooves, wherein the lands and grooves comprise a pitch of about 0.05 to about 0.7 micrometer, and wherein the lands have a width of about 10 to about 200 nanometers, preferably about 25 to about 100 nanometers, and more preferably about 45 to about 80 nanometers.

In yet anther embodiment, a data storage medium comprises a substrate layer comprising a blend of poly(arylene ether) resin and poly(alkenyl aromatic) resin; wherein the substrate layer comprises a surface comprising lands and grooves, wherein the lands and grooves comprise a pitch of about 0.05 to about 0.7 micrometer, and wherein the lands have a height of about 10 to about 100 nanometers, preferably about 45 to about 80 nanometers.

In yet another embodiment, a data storage medium comprises a substrate layer comprising a blend of poly(arylene ether) resin and poly(alkenyl aromatic) resin; wherein the substrate layer comprises a surface comprising lands and grooves, wherein the lands and grooves comprise a pitch of about 0.05 to about 0.7 micrometer, and wherein the grooves have a width of about 10 to about 200 nanometers, preferably about 25 to about 100 nanometers, and more preferably a width of about 45 to about 80 nanometers.

In another embodiment, a data storage medium comprises a substrate layer comprising a blend of poly(arylene ether) resin and poly(alkenyl aromatic) resin; wherein the substrate layer comprises a surface comprising lands and grooves, wherein the lands and grooves comprise a pitch of about 0.05 to about 0.7 micrometer, and wherein the grooves have a height of about 10 to about 100 nanometers, and preferably about 45 to about 80 nanometers.

In another embodiment, a data storage medium comprises a substrate layer comprising a blend of poly(arylene ether) resin and poly(alkenyl aromatic) resin; wherein the substrate layer comprises a surface comprising lands and grooves, wherein the lands and grooves comprise a pitch of about 0.05 to about 0.7 micrometer, and wherein the substrate layer has a thickness of about 0.2 millimeter to about 2.5 millimeters, preferably about 0.5 millimeter to about 1.3 millimeters, and more preferably about 0.8 millimeter to about 1.0 millimeter.

In another embodiment, a data storage medium comprises a substrate layer comprising a blend of poly(arylene ether) resin and poly(alkenyl aromatic) resin; wherein the substrate layer comprises a surface comprising lands and grooves, wherein the lands and grooves comprise a pitch of about 0.05 to about 0.7 micrometer, and wherein the substrate layer has a land and groove replication of greater than or equal to about 90 percent, preferably greater than or equal to about 95 percent, and more preferably greater than or equal to about 98 percent.

In another embodiment, a data storage medium comprises a substrate layer comprising a blend of poly(arylene ether) resin and poly(alkenyl aromatic) resin; wherein the substrate layer comprises a surface comprising lands and grooves, wherein the lands and grooves comprise a pitch of about 0.05 to about 0.7 micrometer, and wherein the blend comprises poly(arylene ether) and poly(alkenyl aromatic) at a weight ratio of about 80:20 to about 20:80, preferably at a weight ratio of about 60:40 to about 40:60, and more preferably at a weight ratio of about 48:52 to 52:48.

In another embodiment, a data storage medium comprises a substrate layer comprising a blend of poly(arylene ether) resin and poly(alkenyl aromatic) resin; wherein the substrate layer comprises a surface comprising lands and grooves, wherein the lands and grooves comprise a pitch of about 0.05 to about 0.7 micrometer, and wherein the blend is substantially free of particulate impurities having sizes greater than or equal to about 50 percent of the narrowest thickness of the substrate layer, more preferably greater than or equal to about 25 percent of the narrowest thickness of the substrate layer, and even more preferably greater than or equal to about 5 percent of the narrowest thickness of the substrate layer.

In another embodiment, a data storage medium comprises a substrate layer comprising a blend of poly(arylene ether) resin and poly(alkenyl aromatic) resin; wherein the substrate layer comprises a surface comprising lands and grooves, wherein the lands and grooves comprise a pitch of about 0.05 to about 0.7 micrometer, and wherein the poly(arylene ether) comprises a plurality of structural units of the structure: 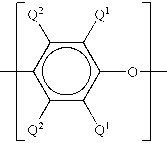
wherein for each structural unit, each Q¹ is independently halogen, primary or secondary C₁-C₇ alkyl, phenyl, haloalkyl, aminoalkyl, hydrocarbonoxy, or halohydrocarbonoxy wherein at least two carbon atoms separate the halogen and oxygen atoms; and each Q² is independently hydrogen, halogen, primary or secondary lower alkyl, phenyl, haloalkyl, hydrocarbonoxy, or halohydrocarbonoxy wherein at least two carbon atoms separate the halogen and oxygen atoms, and/or the poly(arylene ether) has an intrinsic viscosity of about 0.10 to about 0.60 deciliters per gram as measured in chloroform at 25° C., and/or the poly(arylene ether) is poly(2,6-dimethylphenylene ether) or poly(2,6-dimethylphenylene ether-co-2,3,6-trimethylphenylene ether).

In another embodiment, a data storage medium comprises a substrate layer comprising a blend of poly(arylene ether) resin and poly(alkenyl aromatic) resin, wherein the substrate layer comprises a surface comprising lands and grooves, wherein the lands and grooves comprise a pitch of about 0.05 to about 0.7 micrometer; a data layer disposed on the substrate; and an optical layer disposed on the data layer opposite to the substrate layer, wherein the optical layer comprises a polycarbonate or a silicone hard coat; and wherein the data storage medium exhibits a radial tilt change value after 96 hours at 80° C. of less than or equal to 0.5 degree at a radius of 55 millimeters, and preferably less than or equal to 0.35 degree.

In one embodiment, a data storage medium comprises a substrate layer comprising a blend of poly(arylene ether) resin and polystyrene resin in a weight ratio of about 10:90 to about 90:10; a data layer disposed on the substrate layer; and an optical layer disposed on the data layer opposite to the substrate, wherein the optical layer comprises 1,3-bis(4-hyroxyphenyl)menthane polycarbonate or bisphenol-A polycarbonate; wherein the data storage medium exhibits a radial tilt change value after 96 hours at 80° C. of less than or equal to 0.35 degree at a radius of 55 millimeters.

In one embodiment, a data storage medium comprises a substrate layer comprising a blend of poly(arylene ether) resin and polystyrene resin in a weight ratio of about 40:60 to about 60:40; a data layer disposed on the substrate layer; and an optical layer disposed on the data layer opposite to the substrate, wherein the optical layer comprises 1,3-bis(4-hyroxyphenyl)menthane polycarbonate or bisphenol-A polycarbonate; wherein the data storage medium exhibits a radial tilt change value after 96 hours at 80° C. of less than or equal to 0.35 degree at a radius of 55 millimeters.

In another embodiment, a data storage medium comprises a substrate layer comprising a blend of poly(arylene ether) resin and poly(alkenyl aromatic) resin in a weight ratio of about 40:60 to about 60:40, wherein the substrate layer comprises a surface comprising lands and grooves and wherein the lands and grooves comprise a pitch of about 0.2 to about 0.4 micrometer; a data layer disposed on the substrate layer; and an optical layer disposed on the data layer opposite to the substrate, wherein the optical layer comprises 1,3-bis(4-hyroxyphenyl)menthane polycarbonate or bisphenol-A polycarbonate.

In yet another embodiment, a data storage medium comprises a substrate layer comprising a blend of poly(arylene ether) resin and poly(alkenyl aromatic) resin; and a data layer disposed on the substrate layer, wherein the substrate layer comprises a surface comprising lands and grooves of a dimension wherein the data layer is capable of being read using a laser having a wavelength of less than about 420 nanometers and a numerical aperture of greater than or equal to about 0.6.

All references, patents and patent applications referred to herein are hereby incorporated by reference in their entirety. The following examples are included to provide additional guidance to those skilled in the art in practicing the claimed invention. The examples provided are merely representative of the present disclosure. Accordingly, the following examples are not intended to limit the invention, as defined in the appended claims, in any manner.

### EXAMPLES

Preparation of data disk assembly samples: Disk substrates for the following examples were prepared by injection molding polymeric material using a Sumitomo Heavy Industries, Ltd. SD30 Injection Molding Machine with a Siekoh Giken Type J CD mold. The mold includes a “stamper” having features of grooves of a particular geometry. Typical polymer melt “shot” sizes were approximately 20 grams of material. One surface of the molded disk substrate contained the “negative” pattern of grooves from the mold surface. The patterned surface of the molded substrate was metallized with aluminum to a standard thickness of 0.05 to 0.10 micrometers through a “sputtering” process. A pressure sensitive adhesive layer (approximately 25 micrometers in thickness) was applied to the metallized portion of the substrate followed by an optical layer (about 75 micrometers in thickness) using a nitto tape applicator manufactured by Record Products of America. The data disk assembly was completed by pressing the stack in a Carver laminator press at 60° C. and 80 pounds per square inch (psi; 5.6 kgf/cm²) for 5 minutes to fully bond the layers.

### Comparative Example 1 and Examples 1 and 2

Room temperature step humidity change effect on the radial tilt of data disk assemblies.

A humidity shock test was performed on data disk assemblies to explore their dimensional stability under an elevated humidity environment. The radial tilt of a disk assembly may be influenced by absorption or desorption of water in any or all of the assembly layers. As polymeric layers absorb moisture and equilibrate to the changed environment, a disk may experience warpage due to the materials involved and the asymmetry of the system. In Comparative Example 1 and Examples 1-2, radial tilt of the disk assemblies was measured as the disks are taken at time zero, from a 25° C. and 50% relative humidity environment to an environment of 25° C. and 90% relative humidity. The radial tilt was measured using a Dr. Schenk Prometeus model MT-136E analyzer measuring radial deviation, or twice the radial tilt, as a function of disk radius (measured at a radius of 55 millimeters), using a red laser and modeling the disks as having CD-R format.

### Comparative Example 1

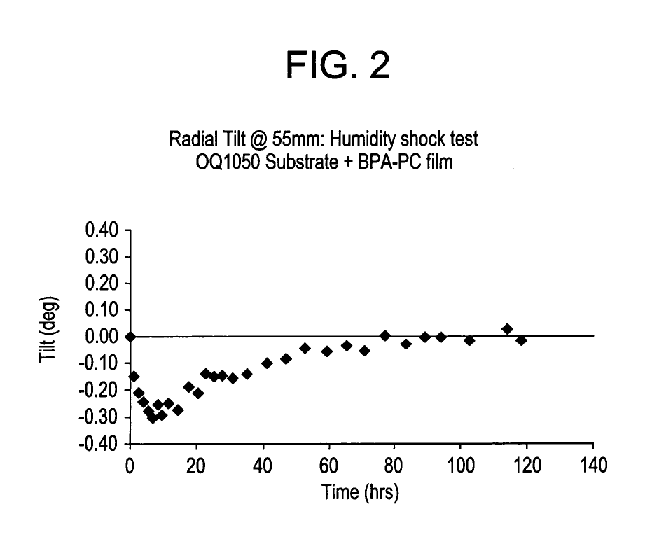

A data disk assembly was prepared from a 1.1 millimeter (mm) thick substrate made from bisphenol-A polycarbonate resin (OQ1050, Optical quality polycarbonate available from GE Plastics) onto which was sputtered a thin aluminum reflective data layer, followed by a 75 micrometer thick optical layer made from bisphenol-A polycarbonate (BPA-PC) which was bonded via an optical quality pressure sensitive adhesive. The disk assembly was subjected to the humidity shock test and the tilt of the disk was measured as a function of time. The results of the humidity shock test are depicted in FIG. 2.

### Example 1

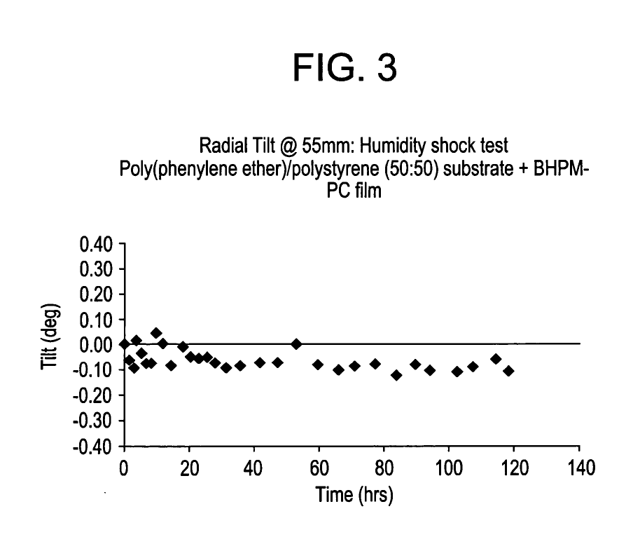

A data disk assembly was made from a substrate prepared from a blend of 50 weight percent (wt %) 0.33 intrinsic viscosity (IV, as measured in chloroform at 25° C.) poly(2,6-dimethyl-1,4-phenylene ether) (PPE) and 50 wt % crystal polystyrene (xPS) having a weight average molecular weight (Mw) of 270,000 amu (L3450 grade available from Chevron Phillips Chemical), and a optical film layer prepared from 1,3-bis(4-hydroxyphenyl)menthane polycarbonate (BHPM-PC). The blend of PPE/xPS used was melt filtered according to the procedure in Examples 9-12 below. The thicknesses of the layers in the assembly were the same as in Comparative Example 1. The disk assembly was subjected to the humidity shock test and the results are depicted in FIG. 3.

### Example 2

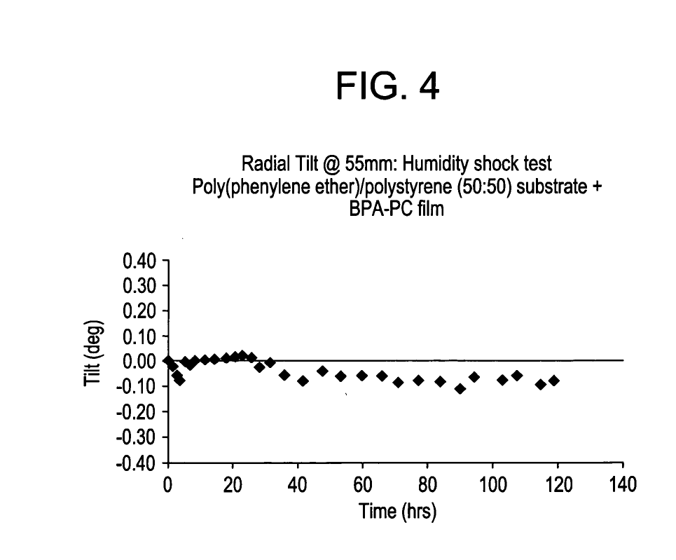

In this example, the substrate was prepared from the same material as for Example 1, but the optical film layer was prepared from bisphenol-A polycarbonate (BPA-PC). Again, the layers were of the same thickness as those in Comparative Example 1. FIG. 4 provides the results of the humidity shock test for Example 2.

As illustrated in Examples 1 and 2, the disk assemblies prepared from a poly(phenylene ether)/polystyrene blend substrate and a polycarbonate film exhibited significantly less radial tilt under high humidity conditions as compared to the assembly prepared from a polycarbonate substrate and a polycarbonate film (Comparative Example 1). The mimimum tilt is desired for the maintenance of the integrity of the data read/write capability.

### Example 3

Aging of the data disk assemblies and the effect of formulation and molecular weight.

Data disk assemblies having substrates prepared from various blends of PPE and xPS were made to illustrate the effect of molecular weight and blend composition on substrate dimensional stability. Four different formulations of PPE/xPS blends were prepared and injection molded into disk substrates using the molding conditions described above. The formulations can be found in Table 1. Two PPEs and two xPS were varied in the formulations: 0.33 IV and 0.46 IV poly(2,6-dimethylphenylene ether)s, L3450 grade polystyrene available from Chevron Phillips Chemical having a weight average molecular weight of 270,000 amu (High MW xPS) and L3050 grade polystyrene available from Novacor having a weight average molecular weight Mw 214,000 amu (Low MW xPS). All of the data disk assemblies of Example 3 contained a BHPM-PC optical film layer.

TABLE 1

| Components (weight %) | |
|---|---|
| PPE (IV) | xPS |

| Formulation | 0.46 | 0.33 | High MW | Low MW |
|---|---|---|---|---|
| 1 | — | 40.00 | — | 60.00 |
| 2 | — | 50.00 | 50.00 | — |
| 3 | 40.00 | — | — | 60.00 |
| 4 | 50.00 | — | 50.00 | — |

Table 2 further provides viscosity data for the four formulations as measured at a temperature of 300° C. according to ASTM D3835. The shear rate is in inverse seconds (Rate l/s) and the viscosity is in units of Pascal-second (Pa-s).

TABLE 2

Formulation Viscosity
(Pa-s)

| Rate (1/s) | 1 | 2 | 3 | 4 |
|---|---|---|---|---|
| 6080.6 | 39 | 54.2 | 46.3 | 65.9 |
| 4706.4 | 45.2 | 62.2 | 53.9 | 78.3 |
| 3648.4 | 52.2 | 72.6 | 63.2 | 92.7 |
| 2821.4 | 60 | 84.7 | 73.6 | 110.2 |
| 2189 | 70 | 98.1 | 86.4 | 127.3 |
| 1690.4 | 80.6 | 113.3 | 100.4 | 149.3 |
| 1313.4 | 92.1 | 130.1 | 116.5 | 173.6 |
| 1009.4 | 104.2 | 151.1 | 136.2 | 204.3 |
| 790.5 | 116.1 | 174.2 | 156.7 | 236.4 |
| 608.1 | 131.1 | 202.6 | 181.1 | 272.3 |

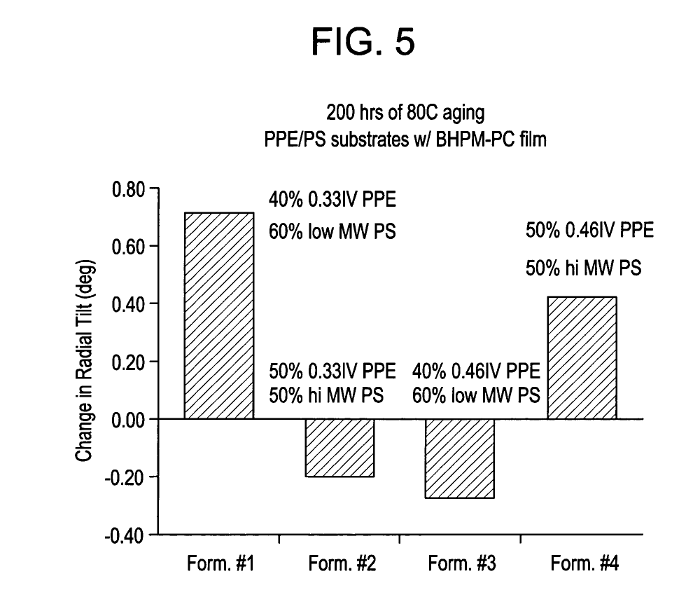

The assemblies were subjected to thermal aging at 80° C. for 200 hours and 50% relative humidity. The difference in tilt was determined by measuring the tilt before and after thermal aging, and the results of the aging study are provided in FIG. 5. As illustrated in FIG. 5, varying the ratio of poly(phenylene ether) to polystyrene as well as the molecular weight and intrinsic viscosities of each component in the blend had a significant effect on the dimensional stability of the resulting substrates. By carefully choosing the ratios of components and their physical properties, it was surprisingly found that a substrate can be molded having significantly reduced molded in stresses. The reduction in molding in stresses translates into a data disk assembly prepared from the substrate having superior dimensional stability over time and/or at elevated temperatures. As shown, the best results were obtained with substrates prepared from a 1:1 blend of 0.33 IV PPE and High MW xPS.

### Example 4

Aging of substrate and effect of molding conditions on substrate shrinkage.

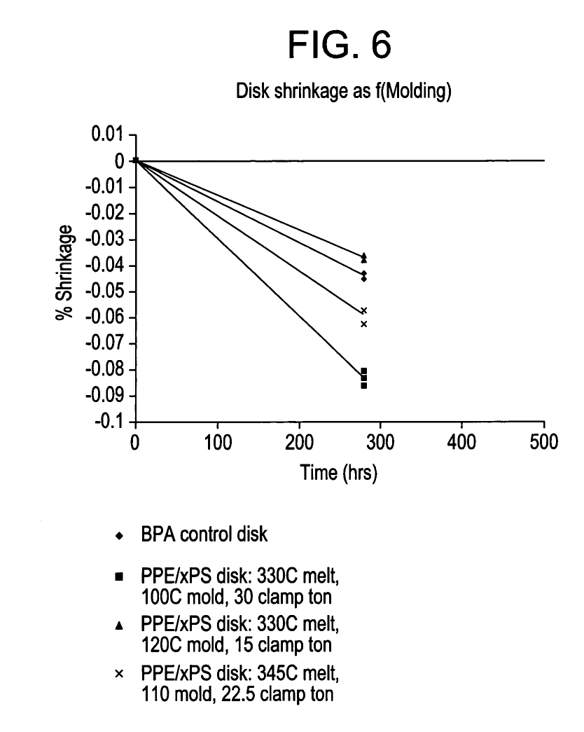

As mentioned previously, radial tilt change at 80° C. is believed to be caused primarily by relaxation of stresses in the injection molded substrate. The substrate relaxes and changes volume at elevated temperatures, such as 80° C., while the other layers of the assembly—the metal, adhesive, and optical layer—either do not change or change at a different rate. It has been determined that the shrinkage and stress relaxation can be greatly influenced by changing the conditions at which the disk is molded for any given composition of PPE-PS. FIG. 6 depicts this phenomenon via shrinkage measurements done on unmetallized injection molded disk substrates after exposure to an 80° C. environment. A single formulation was used in this example: 50 wt % 0.33iv poly(2,6-dimethylphenylene ether) and 50 wt % crystal polystyrene of 270,000 weight average molecular weight available from Chevron Phillips Chemical. The molding conditions used to prepare the disk substrates were melt temperature (melt), mold temperature (mold), and clamp tonnage (clamp ton). A comparative example of a substrate made from BPA-PC is also provided. As illustrated in FIG. 6, varying three molding conditions provided substrates having a range of dimensional stability under elevated temperature conditions.

For any given composition of PPE-PS, the stress relaxation of molded in stresses, and hence the radial tilt change at 80° C. aging, can be reduced significantly through an examination and optimization of these injection molding conditions. The optimized conditions for molding PPE-PS blends are described in U.S. Application Ser. No. ______, docket no. 134717-1, entitled “Method of Molding Articles” commonly owned and co-pending with the present application. A further exploration of molding conditions of substrates on the dimensional stability of data disk assemblies prepared therefrom can be found in the following examples.

### Example 5

Aging of substrate and effect of molding conditions on radial tilt change of disk assembly.

The effect of molding conditions on disk assembly warpage after a thermal aging exposure is illustrated in this example. All disk substrates in these assemblies were prepared from the blend of 50 wt % 0.33iv poly(2,6-dimethylphenylene ether) and 50 wt % crystal polystyrene of 270,000 weight average molecular weight available from Chevron Phillips Chemical. Disks were molded under varying molding conditions as summarized in Table 3. Seventeen production runs were performed to produce disk substrates; the melt temperature and the mold temperature are in degrees Celsius (° C.), the clamp tonnage is in tons, the hold pressure is in kilogram-force per centimeter squared (kgf/cm²) and the cool time is in seconds.

TABLE 3

| | | | | | | Average 80° C., | |
|---|---|---|---|---|---|---|---|
| | | | | | | 96 hour radial tilt | |
| | Melt | Mold | Clamp | Hold | Cool | change @ 55 mm | Std. |
| Run | Temp | Temp | Ton | Pressure | Time | (degrees) | Dev. |
| 1 | 330 | 100 | 30 | 25 | 12 | 0.343 | 0.055 |
| 2 | 330 | 100 | 30 | 5 | 7 | 0.412 | 0.125 |
| 3 | 330 | 100 | 15 | 25 | 7 | 0.258 | 0.025 |
| 4 | 330 | 100 | 15 | 5 | 12 | 0.263 | 0.020 |
| 5 | 330 | 120 | 15 | 5 | 7 | 0.128 | 0.020 |
| 6 | 330 | 120 | 15 | 25 | 12 | 0.100 | 0.108 |
| 7 | 330 | 120 | 30 | 25 | 7 | 0.218 | 0.116 |
| 8 | 330 | 120 | 30 | 5 | 12 | 0.348 | 0.125 |
| 9 | 345 | 110 | 22.5 | 15 | 9.5 | 0.268 | 0.025 |
| 10 | 360 | 100 | 30 | 25 | 7 | 0.467 | 0.115 |
| 11 | 360 | 100 | 30 | 5 | 12 | 0.473 | 0.018 |
| 12 | 360 | 100 | 15 | 25 | 12 | 0.297 | 0.040 |
| 13 | 360 | 100 | 15 | 5 | 7 | 0.305 | 0.013 |
| 14 | 360 | 120 | 15 | 25 | 7 | 0.213 | 0.010 |
| 15 | 360 | 120 | 15 | 5 | 12 | 0.263 | 0.102 |
| 16 | 360 | 120 | 30 | 5 | 7 | 0.325 | 0.038 |
| 17 | 360 | 120 | 30 | 25 | 12 | 0.475 | 0.108 |
| CE 2 | — | — | — | — | — | 0.505 | 0.038 |

The molded substrates were made into data disk assemblies by metallizing the surface with aluminum to a standard thickness of about 0.05-0.10 micrometers by a sputtering process. A pressure sensitive adhesive layer (approximately 25 micrometers in thickness) was applied to the metallized portion of the disk followed by an optical film layer of 1,3-bis(4-hydroxyphenyl)menthane polycarbonate (BHPM-PC) (75 micrometers in thickness) using a nitto tape applicator manufactured by Record Products of America. The disk assembly was completed by placing the stack in a Carver laminator press at 60° C. and 80 pounds per square inch (psi; 5.6 kgf/cm²) for 5 minutes to fully bond the layers.

These assemblies were then equilibrated to ambient conditions, and the initial radial tilt measured on each disk assembly. Thereafter, the disks were exposed to 80° C. for 96 hours, then re-equilibrated to ambient temperature and measured for radial tilt again. The change in tilt caused by the 80° C. environment is provided in Table 3.

Table 3 also contains Comparative Example 2 (CE2) which is a bisphenol-A polycarbonate (BPA-PC) disk of OQ1050 bonded to a BPA-PC optical layer using the same adhesive as the assemblies prepared from Runs 1-17. It was unexpectedly determined that certain molding parameters, for example mold temperature, melt temperature, and clamp tonnage, had a significant effect on the dimensional stability of the PPE-PS based assemblies as evidenced in the radial tilt change values. It was unexpectedly found that the molding parameters of melt temperature, mold temperature, and clamp tonnage had greater influence in the dimensional stability of the substrate as compared to cool time and hold pressure. Optimizing these molding parameters can be made to provide substrates prepared from PPE-XPS blends having excellent stability.

### Examples 6-7

Groove replication of injection molded disk substrates measured as a function of molding conditions.

Example 6. A blend comprising 50 wt % 0.33iv poly(2,6-dimethylphenylene ether) and 50 wt % crystal polystyrene of 270,000 weight average molecular weight was used as the substrate material. The mold “stamper” features on the surface of the substrates were measured to obtain a percent replication. The percent replication was determined by measuring the groove depth of the disk feature using an atomic force microscope and dividing the number obtained by the measurement of the corresponding mold stamper pattern feature and multiplying by 100. The percent replication data provided in Table 4 represents an average value.

TABLE 4

| Run | MeltTemp | MoldTemp | ClampTon | % Replication |
|---|---|---|---|---|
| 18^{a} | 340 | 100 | 20 | 61.4% |
| 19^{b} | 340 | 105 | 30 | 98.8% |
| 20 | 340 | 110 | 15 | 59.0% |
| 21 | 340 | 120 | 25 | 101.7% |
| 22 | 350 | 100 | 15 | 50.7% |
| 23 | 350 | 110 | 25 | 89.6% |
| 24 | 350 | 110 | 25 | 107.6% |
| 25 | 350 | 110 | 25 | 94.6% |
| 26 | 350 | 120 | 20 | 99.2% |
| 27 | 360 | 100 | 30 | 79.6% |
| 28 | 360 | 105 | 20 | 80.2% |
| 29 | 360 | 120 | 15 | 108.0% |
| 30 | 360 | 120 | 30 | 98.5% |
| 31 | 350 | 120 | 20 | 92.0% |
| 32 | 340 | 120 | 25 | 95.3% |

^{a}Average of six disk assemblies, three BHPM-PC and three BPA-PC (Runs 18, 21, 26, 27, 29, and 30)
^{b}Average of three BHPM-PC disk assemblies (Runs 19, 20, 22-25, 28, 31, and 32)

As illustrated by the results in Table 4, the percent replication can vary as much as 50 percent depending upon the molding parameters used to prepare the substrate. Excellent groove replication (>90%) was observed for higher mold temperatures and higher melt temperature. As with dimensional stability, the conditions used to mold the substrate had a surprisingly great effect on the replication of the stamper groove features. By careful choice of molding conditions, it was determined that a substrate can be prepared from a blend of poly(arylene ether) and poly(alkenyl aromatic) exhibiting both excellent feature replication and dimensional stability.

Example 7. Table 5 summarizes the results of groove replication for disks prepared from a resin blend comprising 40 wt % 0.33 IV poly(2,6-dimethylphenylene ether) and 60 wt % crystal polystyrene of 270,000 amu weight average molecular weight, L3450 grade available from Chevron Phillips Chemical. The moving side (MS) of the mold was measured for temperature in degrees Celsius and the mold temperature offset (Mold Temp Offset) is the difference in temperature between the stationary side and the moving side. The injection velocity is provided in units of millimeter per second (mm/s). Again, excellent replication (>90%) was observed for higher mold temperatures and higher melt temperature.

TABLE 5

| | | MS | Mold | Injection | Hold | | |
|---|---|---|---|---|---|---|---|
| | Melt | Mold | Temp | Velocity | Press | Clamp | % Groove |
| Run | Temp | Temp | Offset | (mm/s) | (bar) | Ton (%) | Replication |
| 33 | 340 | 90 | −4 | 105 | 650 | 60 | 77.83 |
| 34 | 340 | 90 | −4 | 125 | 650 | 80 | 68.67 |
| 35 | 340 | 90 | 4 | 105 | 850 | 80 | 78.39 |
| 36 | 340 | 90 | 4 | 125 | 850 | 60 | 72.13 |
| 37 | 340 | 100 | −4 | 125 | 850 | 60 | 92.93 |
| 38 | 340 | 100 | −4 | 105 | 850 | 80 | 95.34 |
| 39 | 340 | 100 | 4 | 105 | 650 | 60 | 90.84 |
| 40 | 340 | 100 | 4 | 125 | 650 | 80 | 95.42 |
| 41 | 340 | 100 | −4 | 125 | 850 | 60 | 92.21 |
| 42 | 350 | 95 | 0 | 115 | 750 | 70 | 91.73 |
| 43 | 360 | 90 | −4 | 125 | 850 | 80 | 86.99 |
| 44 | 360 | 90 | −4 | 105 | 850 | 60 | 88.11 |
| 45 | 360 | 90 | 4 | 105 | 650 | 80 | 84.82 |
| 46 | 360 | 90 | 4 | 125 | 650 | 60 | 84.34 |
| 47 | 360 | 100 | −4 | 125 | 650 | 60 | 95.90 |
| 48 | 360 | 100 | −4 | 105 | 650 | 80 | 94.22 |
| 49 | 360 | 100 | 4 | 105 | 850 | 60 | 93.98 |
| 50 | 360 | 100 | 4 | 125 | 850 | 80 | 101.61 |
| 51 | 360 | 100 | −4 | 125 | 650 | 60 | 96.95 |
| 52 | 360 | 100 | −4 | 125 | 850 | 85 | 103.37 |
| 53 | 360 | 100 | −4 | 125 | 650 | 70 | 105.78 |
| 54 | 360 | 100 | −4 | 125 | 850 | 70 | 100.32 |
| 55 | 360 | 100 | −4 | 125 | 650 | 85 | 98.63 |
| 56 | 360 | 100 | −4 | 125 | 850 | 85 | 97.83 |
| 57 | 360 | 100 | 0 | 125 | 750 | 78 | 102.09 |
| 58 | 360 | 100 | 4 | 125 | 850 | 70 | 91.89 |
| 59 | 360 | 100 | 4 | 125 | 650 | 85 | 93.73 |
| 60 | 360 | 100 | 4 | 125 | 650 | 70 | 102.97 |
| 61 | 360 | 100 | 4 | 125 | 850 | 85 | 102.81 |

### Examples 8-12 and Comparative Examples 2-4

Preparation of blends of polyphenylene ether and polystyrene having reduced amounts of particulate impurities.

One example (Example 8) and one comparative example (Comparative Example 2) were prepared to demonstrate the effect of filtering solutions of polyphenylene ether-polystyrene resin blends on the amount of particulate impurities of the resulting isolated material.

### Example 8

A 40/60 by weight blend of polyphenylene ether (PPE, 0.33 IV PPE powder available from GE Plastics) and polystyrene (xPS, L3050) was prepare according to the following procedure. To a pre-heated (about 125° C.) nitrogen blanketed, stirred amount of reagent-grade ortho-dichlorobenzene (ODCB) was added 72.6 kilograms (kg) of PPE powder and 108.9 kg of xPS, to form a solution containing 20 percent by weight solids. The solution was heated to about 170° C. and gravity filtered through a 5-micrometer size filter bag.

After the first filtration step was completed, a portion of the ODCB was removed by distillation to pre-concentrate the 20 percent by weight solids solution to a polymer-solvent mixture containing about 40 percent by weight solids. The polymer-solvent mixture was charged to a feed tank and maintained at a temperature of about 160° C. and a pressure of about 80 psig (5.6 kg/cm²) under nitrogen. A gear pump was used to transfer the polymer-solvent mixture at a rate of about 72 pounds of solution per hour (32.7 kg/hr) to a shell-and-tube heat exchanger maintained at about 310° C. (590° F.). Nitrogen was used to provide enough pressure (about 80 psig, 5.6 kg/cm²) to feed the pump head of the gear pump.

The polymer-solvent mixture emerged from the heat exchanger having a temperature of about 270-280° C. and was fed through a parallel combination of two sintered-metal filters (PALL, 13-micrometer size pleated filters, surface area of about 1.5 ft² per filter (0.14 m²) to remove particulate impurities within the feed solution. The temperature of the filter housings was maintained at about 280° C.

The filtered polymer-solvent mixture was then fed through a pressure control flash valve plumbed into the downstream edge of barrel 2 of a 10 barrel, 25 mm diameter, twin-screw, co-rotating intermeshing extruder having a L/D ratio of about 40. The temperature of the solution at the pressure-control flash valve was about 280-285° C. The extruder was operated at a screw speed of about 575 rpm and at about 20 percent drive torque. The measured extruder barrel temperatures were 321, 299, 318, 291, 290, 290, 289, and 290° C. (die).

The extruder was equipped with a closed chamber upstream of barrel 1, the closed chamber having a nitrogen line adapted for the controlled introduction of nitrogen gas before and during the solvent removal process. The extruder was further equipped at barrel 2 with a side feeder positioned orthogonal to the barrel of the extruder. The side feeder was not heated, had a L/D of about 10, and comprised two screws consisting of forward conveying elements only. At the end most distant from the extruder barrel, the side feeder was equipped with a single atmospheric vent (vent 1). The conveying elements of the screws of the side feeder were configured to convey toward the extruder and away from the side feeder vent.

The extruder was further equipped with two additional atmospheric vents at barrel 1 (vent 2), and barrel 4 (vent 3), and three vacuum vents (vents operated at subatmospheric pressure) at barrel 5 (vent 4), barrel 7 (vent 5) and barrel 9 (vent 6). The three atmospheric vents, two on the extruder and one on the side feeder, were each connected to a solvent removal and recovery manifold comprising solvent vapor removal lines, a condenser and liquid solvent receiving vessel. The vacuum vents were similarly adapted for solvent recovery. Vents 3, 4, 5 and 6 were equipped with Type “C” inserts. Vents 1 and 2 were not equipped with a vent insert.

The extruder screw elements consisted of both conveying elements and kneading elements. All of the conveying elements in both the extruder and the side feeder were forward flighted conveying elements. Kneading elements used included neutral, forward flighted and rearward flighted kneading elements depending on function. In barrels 2 and 3 of the extruder, kneading blocks consisting of forward and neutral flighted kneading elements were employed. The extruder screws were equipped with melt seals consisting of kneading blocks made up of rearward flighted kneading elements. The melt seals were located at barrels 5, and 8. The vacuum vents were located downstream of the melt seals on barrel 5, barrel 7 and barrel 9, and were operated at vacuum levels of about 28 inches of mercury (Hg) (711.2 mm of Hg, a vacuum gauge indicating full vacuum, or zero absolute pressure, would read about 30 inches of mercury or 762 mm of Hg).

Shell-and-tube heat exchangers were used as condensers to recover the ODCB solvent removed in the process. A slight vacuum (about 1 inch Hg, 25.4 mm of Hg) was applied to the heat exchanger receiving solvent vapor from the atmospheric vents to evacuate the solvent vapors. The devolatilized PPE-xPS resin which emerged from the die face (melt temperature about 310° C.) of the extruder was stranded and pelletized.

Prior to the run, the extruder was thoroughly cleaned by submitting the screws, vent port adaptors, vent inserts, die head/plate to an 454° C. sand-bath, and the extruder barrels were brushed prior to reassembly. The vacuum vents ran clean throughout the run, as determined by visual inspection at least every 15 minutes during the 12-hour long run. Only one filter housing was used for the entire 12-hour experiment. The differential pressure across the filter was constant throughout the run. Table 6 provides the processing data for Example 8.

TABLE 6

| | | | | | | | | Temp | |
|---|---|---|---|---|---|---|---|---|---|
| | | | | | | Temp. of | Temp. of | of Heating | |
| | Solution | | Melt | Screw | Actual Barrel | Solution | Feed after Heat | Oil for Heat | Temp. of Feed |
| | Mass Flow | Torque | Temp | speed | Temperatures | at Feed | Exchanger | Exchanger | at Pressure |
| Example | Rate (kg/hr) | (%) | (° C.) | (rpm) | (° C.) | Tank (° C.) | (° C.) | (° C.) | valve (° C.) |
| 8 | 32.7 | 20 | 310 | 575 | 321/299/318/ | 160 | 270-280 | 310 | 280-285 |
| | | | | | 291/290/290/ | | | | |
| | | | | | 289/290 (die) | | | | |
| CE-2 | 13.9-15.9 | 20 | 305 | 450 | 317/289/289/ | 162 | — | — | — |
| | | | | | 290/290/290/ | | | | |
| | | | | | 281/290 | | | | |

Comparative Example 2 (CE-2) was prepared similarly to Example 8, with some modifications, most importantly the PPE-xPS solution was filtered only once by gravity filtration through a filter bag. Additionally, the solution was not super-heated prior to its incorporation to the extruder used for isolation. A solution of PPE-xPS was prepared by combining 12.1 kg of 0.33 IV PPE powder and 18.1 kg of L3050 grade xPS in enough ODCB to form a 10 percent by weight solids solution. The resulting solution was heated to about 170° C. and gravity filtered through a 5-micrometer sized filter bag. The filtrate was concentrated to about a 40 percent by weight solids solution by removal of ODCB by distillation.

The solution was not superheated in a shell-and-tube heater and was not filtered through a combination of two sintered-metal filters prior to isolation of the polymeric material from the solvent. Isolation of the polymeric material was performed in a 25 mm-diameter twin-screw, co-rotating intermeshing extruder having 10 barrels (L/D=40); a 2-hole die plate; and six vents, two of which were located upstream of the feed port and operated at atmospheric pressure, and the other four vents were located downstream of the feed port and operated at relatively high levels of vacuum (about 28 inches of mercury (711.2 mm of Hg)). The atmospheric vents 1 and 2 were located at extruder barrel 1 and on a side feeder connected to barrel 2 of the extruder, respectively. The feed solution was added directly to the extruder at an injection port located at the downstream edge of barrel number 2. A side feeder, operated as a vent, was connected to the extruder at barrel number 2. Finally, the extruder was not cleaned prior to the run, but was purged for some time with the same solution used as the feed. Processing conditions for Comparative Example 2 can be found in Table 6.

Isolated PPE-xPS of Example 8 and Comparative Example 2 were tested for amounts of particulate impurities present in the filtered material. A particulate count of visible particulates was determined according the following procedure. Six, two ounce sample bottles with polyseal caps were subjected to a stream of filtered air to remove any particles present. The bottles were then rinsed with a small amount of chloroform (CHCl₃). Fifty milliliters (mL) of the CHCl₃ was added to each sample bottle and cap. Using a lightbox, the number of visible specks or fibers was recorded for each CHCl₃ blank. A 10.00 gram amount of each sample was weighed out on a clean aluminum pan and added to the bottles containing CHCl₃. Two samples of each isolated polymeric material were prepared along with two blanks. The samples were allowed to dissolve and then viewed in the lightbox for the presence of visible specks. The results of the visible particle analysis for the blank, Example 8, and Comparative Example 2 are found in Table 7.

Particulate impurities ranging in size from 5 to 100 micrometers present in the filtered materials were detected using a Pacific Instruments ABS2 analyzer which employs a laser light scattering technique. A 16.0 gram sample from Example 8 was dissolved in 400 mL of CHCl₃ contained in a clean polyethylene bottle. This procedure was repeated with the Comparative Example 2 material. A 20 mL quantity of each sample solution was allowed to flow through the ABS2 analyzer detector at a flow rate of 1 mL/minute (+/−5%). The amount particulates ranging in size of about 5 to about 100 micrometers present in the sample was measured in the detector during this process. Five samples are taken from each bottle and averaged to yield the final particle size number. The results of the ABS2 analyzer particulate analysis for Example 8 and Comparative Example 2 are found in Table 7.

TABLE 7

| Visible | Example 8 | | Comparative Example 2 | | Blank |
|---|---|---|---|---|---|
| Particles | 3 | 3 | 3 | 4 | 1 |
| Particle size | Raw Data | Blank Corrected | Raw Data | Blank Corrected | Raw Data |
| (micrometers) | Particles/ml | Particles/gram | Particles/ml | Particles/gram | Particles/ml |
| 5 | 21.872 | 456.4 | 64.32 | 1517.60 | 3.616 |
| 10 | 4.12 | 82.4 | 10.736 | 247.80 | 0.824 |
| 15 | 1.912 | 39.6 | 2.264 | 48.40 | 0.328 |
| 20 | 1.704 | 20.4 | 1.848 | 24.00 | 0.888 |
| 30 | 0.44 | 2.2 | 0.848 | 12.40 | 0.352 |
| 40 | 0.04 | −3.2 | 0.072 | −2.40 | 0.168 |
| 50 | 0.408 | 4.2 | 0.707 | 11.68 | 0.24 |
| 100 | 0.336 | 6.6 | 0.224 | 3.80 | 0.072 |

The results of the above experiments show that the method used in Example 8 resulted in PPE-xPS material having significantly reduced amounts of particulate impurities when compared to Comparative Example 2. The additional filtration the solution of Example 8 through a 13 micrometer sintered metal filter resulted in a material having greatly reduced amounts of particulate impurities having sizes of 15 micrometers or smaller.

Example 8 further illustrates the isolation/devolatilization of a relatively low weight percent solids solution comprising polyphenylene ether and polystyrene. The superheating of the polymer-solvent mixture allows for the efficient removal of solvent at twice the flow rate of Comparative Example 2 to provide an isolated polyphenylene ether-polystyrene composite.

Four example runs (Example runs 9-12) were performed to illustrate the method of melt filtering a melt comprising polyphenylene ether and polystyrene to form a polymeric material having reduced levels of particulate impurities.

Example run 9: A 40/60 percent by weight blend of polyphenylene ether (PPE, powder, 0.33 IV available from GE Plastics) and polystyrene (xPS, Novacor 2272; Mw 214,000, Mn 71,600, Mw/Mn 2.99; available from Nova Chemical) was compounded in a 40 millimeter (mm) compounder with a vacuum vent. A vacuum was applied to the vent at about 20 inches of mercury (508 millimeters of Hg). The compounded material was fed to a single screw extruder equipped with 3 barrels (zones). The extruder was equipped with a sintered metal filter (PALL, 3 micrometer pores, candle geometry) located at the extruder die head.

The extruded melt strands were run through a clean, filtered water bath, the water having been filtered through a 10 micrometer filter to remove rust and impurities. The cooled strands of extruded polymeric material were dried and pelletized. Batches of the extruded melt were collected throughout the run, about every half hour. The extruder processing conditions are provided in Table 8.

The procedure of Example run 9 was repeated for Example run 10 except that a 30 mm compounder was employed. The extruder processing conditions for Example run 10 are also provided in Table 8.

The procedure of Example run 9 was repeated for Example runs 11 and 12. The PPE-xPS formulation for Example runs 11 and 12 was a 50/50 percent by weight blend of 0.33 IV PPE and EB3300 grade xPS (Mw 276,000, Mn 51,500, Mw/Mn 5.36; available from Chevron Phillips Chemical). A 40 mm compounder was used for Example run 11, while a 30 mm compounder was used for Example run 12. The processing conditions for Example runs 11 and 12 are provided in Table 8. For all of the Examples the drive, rate, pressure, and melt temperature are averaged for the entire run.

TABLE 8

| | Example | | | |
|---|---|---|---|---|
| | 9 | 10 | 11 | 12 |
| Zone 1 (° C.) | 232 | 232 | 232 | 232 |
| Zone 2 (° C.) | 260 | 260 | 260 | 260 |
| Zone 3 (° C.) | 277 | 277 | 277 | 277 |
| Filter 1 (° C.) | 277 | 277 | 277 | 277 |
| Filter 2 (° C.) | 277 | 277 | 277 | 277 |
| Die (° C.) | 277 | 277 | 277 | 277 |
| Screw (rpm) | 85 | 100 | 85 | 85 |
| Drive (amps) | 8.0 | 7.4 | 10.0 | 11.0 |
| Rate (kg/hr) | 6.1 | 6.9 | 7.0 | 6.8 |
| Filter In Press. (kg/cm²) | 198 | 227 | 201 | 275 |
| Filter Out Press. | 26 | 14 | 25 | 27 |
| (kg/cm²) | | | | |
| Filter In Melt Temp. | 278 | 318 | 279 | 281 |
| (° C.) | | | | |
| Filter Out Melt Temp. | 292 | 298 | 296 | 296 |
| (° C.) | | | | |
| Visible Specks (avg.) | 3.3 | 2 | 1.6 | 1.7 |
| Filter Type/pore size | PALL | PALL | PALL | PALL |
| (micrometer) | candle, 3 | candle, 3 | candle, 3 | candle, 3 |

Samples from the runs of Examples 9-12 were tested for visual particulates according to the following procedure. Samples of polymeric material for each run were taken about every half hour for each of the Example runs (9-12). Each sample was tested twice for visible particulates. Two ounce sample bottles with polyseal caps were subjected to a stream of filtered air to remove any particulates present. The bottles were then rinsed with a small amount of HPLC grade chloroform (CHCl₃). Fifty milliliters (ml) of HPLC grade CHCl₃ was added to each sample bottle. Using a lightbox, the number of visible specks or fibers was recorded for each CHCl₃ blank. A 10.00 gram amount of a sample was weighed out on a clean aluminum pan and added to one of the bottles containing CHCl₃. This procedure was repeated for every sample. The samples were allowed to dissolve and then viewed in the lightbox for the presence of visible specks. An average number of specks were calculated for each run, four runs total (Examples 9-12). The results of the visible particle analysis for Example runs 9-12 are found in Table 9.

Two samples from Example run 10 (Ex. 10, S1 and Ex. 10, S2), one sample from Example run 11 (Ex. 11, S1), and two samples from Example run 12 (Ex. 12, S1 and Ex. 12, S2) were tested for particulate content according to the procedure below. Amounts of particulates having sizes ranging from 5 micrometers to 100 micrometers were determined using a Pacific Instruments ABS2 analyzer which employs a laser light scattering technique. A 40.0 gram amount of each sample was dissolved in 400 ml of HPLC grade CHCl₃ contained in a clean polyethylene bottle. A 20 ml quantity of each sample solution was allowed to flow through the ABS2 analyzer detector at a flow rate of 1 ml/minute (+/−5%). The amount of particulates of varying sizes present in the sample was measured in the detector during this process. Each sample was tested five times and averaged to yield a final number. Two comparative examples were prepared and tested. Comparative Example 3 (CE 3) was an unfiltered blend of 50/50 weight percent 0.33 IV PPE/EB3300 grade xPS. Comparative Example 4 (CE 4) was optical quality polycarbonate (OQ-PC, LEXAN® 1050 available from GE Plastics). The results of the ABS2 analyzer particle analysis in particles per gram can be found in Table 9, along with the blank data (CHCl₃ alone).

TABLE 9

| | Particulate Size (micrometers) | | | | | | | |
|---|---|---|---|---|---|---|---|---|
| Example, | 5 | 10 | 15 | 20 | 30 | 40 | 50 | 100 |
| Sample # | Particles per gram | | | | | | | |
| Ex. 10, | 654.3 | 111 | 38.7 | 23.3 | 3.2 | 0.9 | 1.2 | 0.1 |
| S1 | | | | | | | | |
| Ex. 10, | 561.8 | 91.1 | 34.4 | 16.5 | 1.9 | 0.4 | 0.6 | 0.1 |
| S2 | | | | | | | | |
| Ex. 11, | 689.8 | 90 | 32.7 | 15.6 | 2.6 | 0.5 | 0.4 | 0.1 |
| S1 | | | | | | | | |
| Ex. 12, | 1919.9 | 143.7 | 44.3 | 20.1 | 2.4 | 0.6 | 0.2 | 0 |
| S1 | | | | | | | | |
| Ex. 12, | 1117.5 | 114.8 | 42.9 | 26.6 | 3.6 | 1.8 | 0.2 | 0 |
| S2 | | | | | | | | |
| CE 3 | 6901.25 | 1237.5 | 500 | 396.25 | 85 | 23.75 | 30 | 5 |
| CE 4 | 317.000 | 58.88 | 52.88 | 14.88 | 3.38 | 0.75 | 0 | 0 |
| CHCl₃ | 15.15 | 3.65 | 1.25 | 0.25 | 0 | 0 | 0 | 0 |

The results of the above experiments illustrate a significant reduction of particulate impurities between the unfiltered sample (CE 3) and the corresponding filtered samples (Ex. 11, S1; Ex. 12, S1; and Ex. 12, S2). Furthermore, the particulate impurity level of the Examples of the present method is comparable to or better than OQ-PC with regard to particulates of 15 micrometers or greater.

1. A data storage medium, comprising:
a substrate layer comprising a blend of poly(arylene ether) resin and poly(alkenyl aromatic) resin;
wherein the substrate layer comprises a surface comprising lands and grooves,
wherein the lands and grooves comprise a pitch of about 0.05 to about 0.7 micrometer.

2. The data storage medium of claim 1, wherein the lands have a width of about 10 to about 200 nanometers.

3. The data storage medium of claim 1, wherein the lands have a height of about 10 to about 100 nanometers.

4. The data storage medium of claim 1, wherein the grooves have a width of about 10 to about 200 nanometers.

5. The data storage medium of claim 1, wherein the grooves have a height of about 10 to about 100 nanometers.

6. The data storage medium of claim 1, wherein the substrate layer has a thickness of about 0.2 millimeter to about 2.5 millimeters.

7. The data storage medium of claim 1, wherein the substrate layer has a land and groove replication of greater than or equal to about 90 percent.

8. The data storage medium of claim 1, wherein the substrate layer is prepared by injection molding the blend at a melt temperature of about 330 to about 370° C. into a mold having a mold temperature of about 90 to about 130° C. and a clamp tonnage of greater than or equal to about 12 tons.

9. The data storage medium of claim 1, wherein the blend has a glass transition temperature greater than or equal to about 120° C.

10. The data storage medium of claim 1, wherein the blend is substantially free of visible particulate impurities.

11. The data storage medium of claim 1, wherein the blend is substantially free of particulate impurities greater than about 15 micrometers in size.

12. The data storage medium of claim 1, wherein the blend is substantially free of particulate impurities having sizes greater than or equal to about 5 percent of the narrowest thickness of the substrate layer.

13. The data storage medium of claim 1, wherein the poly(alkenyl aromatic) contains at least 25 percent by weight of structural units derived from an alkenyl aromatic monomer of the formula 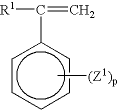
wherein R¹ is hydrogen, C₁-C₈ alkyl, or halogen; Z¹ is vinyl, halogen or C₁-C₈ alkyl; and p is 0 to 5.

14. The data storage medium of claim 1, wherein the poly(alkenyl aromatic) is atactic crystal polystyrene.

15. The data storage medium of claim 1, further comprising a data layer disposed on the substrate.

16. The data storage medium of claim 15, wherein data on the data layer can be read using a laser having a wavelength of less than about 700 nanometers and a numerical aperture lens of greater than or equal to about 0.6.

17. The data storage medium of claim 15, wherein data on the data layer can be read using a laser having a wavelength of less than about 420 nanometers and a numerical aperture lens of greater than or equal to about 0.8.

18. The data storage medium of claim 15, wherein the data layer comprises metal oxides, silicone oxide, rare earth element-transition metal alloys, nickel, cobalt, chromium, tantalum, platinum, terbium, gadolinium, iron, boron, organic dyes, inorganic phase change compounds, phase change chalcogenide alloy, and compositions comprising one or more of the foregoing.

19. The data storage medium of claim 15, further comprising an optical layer disposed on the data layer opposite to the substrate layer, wherein the optical layer comprises a polycarbonate or a silicone hard coat.

20. The data storage medium of claim 19, wherein the optical layer has a thickness of about 25 micrometers to about 0.6 millimeters.

21. The data storage medium of claim 19, wherein the optical layer has a thickness of about 50 to about 120 micrometers.

22. The data storage medium of claim 19, wherein the optical layer comprises a polycarbonate comprising at least one structural unit of: 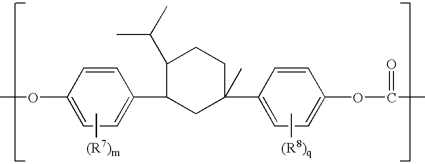
wherein each occurrence of R⁷ and R⁸ is independently selected from the group consisting of C₁-C₆ alkyl and hydrogen; m is an integer of 1 to about 4; and q is an integer of 1 to about 4.

23. The data storage medium of claim 19, wherein the polycarbonate is derived from 1,3-bis(4-hydroxyphenyl)menthane.

24. The data storage medium of claim 19, wherein the optical layer further comprises a polystyrene.

25. The data storage medium of claim 19, wherein the polycarbonate is derived from bisphenol-A.

26. The data storage medium of claim 19, wherein the polycarbonate is a copolymer derived from bisphenol-A and 1,3-bis(4-hydroxyphenyl)menthane.

27. The data storage medium of claim 19, wherein the data storage medium exhibits a radial tilt change value after 96 hours at 80° C. of less than or equal to 0.5 degree at a radius of 55 millimeters.

28. The data storage medium of claim 19, wherein the medium exhibits a change in radial tilt value of less than or equal to about 0.35 degree measured at a radius of 55 millimeters after 10 hours in a 90 percent relative humidity environment.

29. The data storage medium of claim 19, further comprising a reflective layer disposed between the substrate and the data layer.

30. The data storage medium of 29, wherein the reflective layer is aluminum, silver, gold, titanium, alloys, or a composition comprising one or more of the foregoing materials.

31. The data storage medium of claim 19, further comprising a high modulus layer disposed on the optical layer opposite to the data layer.

32. The data storage medium of claim 31, wherein the high modulus layer comprises a copolycarbonate ester or a silicone hard coat.

33. A data storage medium, comprising:
a substrate layer comprising a blend of poly(arylene ether) resin and polystyrene resin in a weight ratio of about 40:60 to about 60:40;
a data layer disposed on the substrate layer; and
an optical layer disposed on the data layer opposite to the substrate, wherein the optical layer comprises 1,3-bis(4-hyroxyphenyl)menthane polycarbonate or bisphenol-A polycarbonate;
wherein the data storage medium exhibits a radial tilt change value after 96 hours at 80° C. of less than or equal to 0.35 degree at a radius of 55 millimeters.

34. The data storage medium of claim 33, wherein the blend is substantially free of visible particulate impurities.

35. The data storage medium of claim 33, wherein the data layer comprises a phase-change chalcogenide alloy.

36. The data storage medium of claim 35, wherein data on the data layer can be read using a laser having a wavelength of less than about 410 nm and a lens numerical aperture of greater than about 0.8.

37. The data storage medium of claim 36, wherein the data storage medium has a recording capacity of greater than about 22 gigabytes and a transfer speed of greater than about 35 megabytes per second.

38. A data storage medium, comprising:
a substrate layer comprising a blend of poly(arylene ether) resin and poly(alkenyl aromatic) resin in a weight ratio of about 40:60 to about 60:40, wherein the substrate layer comprises a surface comprising lands and grooves and wherein the lands and grooves comprise a pitch of about 0.2 to about 0.4 micrometer;
a data layer disposed on the substrate layer; and
an optical layer disposed on the data layer opposite to the substrate, wherein the optical layer comprises 1,3-bis(4-hyroxyphenyl)menthane polycarbonate or bisphenol-A polycarbonate.

39. The data storage medium of claim 38, wherein the blend is substantially free of visible particulate impurities.

40. The data storage medium of 38, wherein the data storage medium exhibits a radial tilt change value after 96 hours at 80° C. of less than or equal to 0.35 degree at a radius of 55 millimeters.

41. The data storage medium of 38, wherein the substrate layer has a land and groove replication of greater than or equal to about 95 percent.

42. A data storage medium, comprising:
a substrate layer comprising a blend of poly(arylene ether) resin and poly(alkenyl aromatic) resin; and
a data layer disposed on the substrate layer,
wherein the substrate layer comprises a surface comprising lands and grooves of a dimension wherein data on the data layer is able to be read using a laser having a wavelength of less than about 420 nanometers and a lens having a numerical aperture greater than about 0.8.

43. The data storage medium of claim 42, wherein the blend is substantially free of visible particulate impurities.

44. A data storage medium, comprising:
a substrate layer comprising a blend of poly(arylene ether) resin and poly(alkenyl aromatic) resin;
a data layer disposed over the substrate layer; and
an optical layer disposed over the data layer opposite to the substrate layer;
wherein the substrate layer comprises a surface comprising lands and grooves, wherein the lands and grooves comprise a pitch of about 0.275 to about 0.35 micrometer;
wherein the data layer comprises a phase-change chalcogenide alloy, and wherein data on the data layer can be read using a laser having a wavelength of less than about 410 nm and a lens numerical aperture of greater than about 0.8;
wherein the optical layer is about 0.050 to about 0.125 mm thick; and
wherein the data storage medium has a recording capacity of greater than about 25 gigabytes and a transfer speed of greater than about 35 megabytes per second.

45. The data storage medium of claim 44, wherein the blend is substantially free of visible particulate impurities.
